(19) United States
(12) Patent Application Publication
(10) Pub. No.: US 2026/0230595 A1
(43) Pub. Date: Aug. 6, 2026

(54) HYBRID SCAN DISPLAY

(71) Applicant: Realfiction Lab ApS., Copenhagen K (DK)

(72) Inventor: Steen Svendstorp Krener-Iversen, Kongens Lyngby (DK)

(73) Assignee: Realfiction Lab ApS., Copenhagen K (DK)

(21) Appl. No.: 19/151,021

(22) PCT Filed: Jan. 29, 2024
(86) PCT No.: PCT/EP2024/052083

§ 371 Date: Jul. 25, 2025

Related U.S. Application Data
(63) Continuation of application No. 18/218,544, filed on Jul. 5, 2023, now abandoned.

(30) Foreign Application Priority Data
Jan. 24, 2023 (EP) 23153677.2
Nov. 8, 2023 (EP) 23208614.0
Jan. 8, 2024 (EP) 24150707.8

(51) Int. Cl. H04N 13/32; G02F 1/1335; H04N 13/315; H04N 13/366; H04N 13/398

(52) U.S. Cl. CPC H04N 13/32; G02F 1/133504; H04N 13/315; H04N 13/366; H04N 13/398

(57) ABSTRACT

A hybrid scan display comprising a plurality of light emitters for emitting light and a plurality of light modulators operated in binary mode and switching between two states including a light transmitting state for transmitting light a light shielding state for shielding light. Each image is divided in a number of parts, and the sequence of image parts for each image are interleaved resulting in an interleaved sequence.

The present disclosure is directed to a new type of display—referred to as “the disclosed display” in the following.

The display has directional pixel technology and it may be called hybrid scan display (HSD display), because an image pixel is defined in one dimension by a light emitting layer and in another dimension by a light modulator layer, which are both scanned in order to display the image.

Thus, it is a different type of display compared to lenticular displays or parallax barrier displays and does not build or modify on any of these types of displays.

The disclosed display directs images to a plurality of viewing regions/zones in front of the display, and it allows multiple users to see multiple individual, artifact-free stereo-scopic images, for example individual perspective images. The display may therefore constitute an autostereoscopic display or a multiview display.

A viewing zone is defined as an active viewing zone/region when there is an observing eye in that viewing zone. Light is not emitted to non-active viewing zones not withstanding the option that 3D content may be displayed to some observers (with eyes in active viewing zones) and 2D content may be displayed to other observers. With 3D content or simply 3D is meant information that defines images to the eyes of an observer that when combined in the brain of the observer results in a depth perception. An example could be a 3D movie. It could also be a 3D movie where the controller of the display may generate a look around effect, e.g. the observer's head and eyes movements will increase information about the 3D objects being displayed—when the observer moves and has a new perspective (angle to the scene), the controller may generate a perspective of the scene corresponding to the new perspective based on the two original images showing the scene. The two original images are the images recorded with the stereo camera used when recording the movie. A neural network may for example be used to generate the new perspective view, e.g. a new right eye image as a function of the original right eye image and a new left eye image as a function of the original left eye image.

In the present disclosure and when referring to the disclosed display, the term “viewing zone” is to be understood as “active viewing zone” unless mentioned otherwise. A non-active viewing zone is a viewing zone in which there is no observer watching the display. In the case of using the display in a multiview situation and not 3D, such as in a car having a viewing zone for the chauffeur and one for the passenger, the display may define the number of active viewing zones even though there might not be a passenger in the car.

It can be configured to have various angular resolution of viewing zones, such as one viewing zone per 1 degree, and can therefore be used to view 3D contents for a very high number of observers. It can also be used simply to show a different image in each viewing zone (called multiview display).

Thus, the disclosed display constitutes an implementation of a multiview display, an autostereoscopic or an automultiscopic display for a plurality of users with no loss of pixel resolution and with look around effect.

Historically, a 3D effect/perception has been achieved with a so called lenticular display or a parallax barrier.

### Comparison to Parallax Barrier Displays

In a parallax barrier display it is the barriers between the slits that block light for achieving a parallax effect and thereby a 3D effect, e.g. the term parallax refers to the effect of a displacement or difference in the apparent position of an object viewed along two different lines of sight, and the barriers block the line of sight between a right eye and left eye pixels and the line of sight between a right eye and left eye pixels respectively. Hence the reason for the name of that type of display.

The purpose of the slits between the barriers in a parallax barrier display is not to emulate an ideal lens moving between different positions during a multiplexing cycle as is the case for the new Disclosed display, e.g. in a parallax barrier display a large fraction, typically around 50%, of the barrier is open at a time. A problem with this principle is, that a large number of undesired light rays are emitted. This causes artifacts, such as image crosstalk, and in practice reduce use cases to a single observer in a restricted viewing zone.

### Multiplexed Parallax Barrier Display

A parallax barrier may be time multiplexed. The barrier of a time multiplexed parallax barrier display may be implemented with liquid crystal cells in order to have control of the “sweet spot” of the parallax barrier display, e.g. the position of the observer can be tracked and based on that it can be determined which liquid crystal cells should be closed and act as a barrier. This can improve the resolution of the image and reduce artifacts to some degree for a single observer, or alternatively for two observers located in very restricted observation/viewing zones. However, even though in some practical implementations of a parallax barrier display, each slit may have a width such that there is some focusing power, this is not something that is used to generate a 3D effect, because as mentioned it is the light blocking of the barrier that is used to achieve the parallax effect and thereby the 3D effect, e.g. the slit is not acting as a horizontally fully illuminated vertical aperture defining the horizontal position of observed pixels like in a lenticular display as is the case in the Disclosed display, but rather the slit is defining an opening through which a pixel in its whole can be observed, hence the pixel's horizontal position is defined by the pixel's position on the display.

In addition, even though a slit in a practical implementation would have some focusing effect, such a slit is not scanned such that it moves during a multiplexing cycle (MP cycle), but typically two sets of slits are alternately opened and closed. This is also why the barrier can be implemented as an opaque layer of static slits in a more simple configuration of a parallax barrier display. This is not something that is possible in the disclosed display, because the aperture needs to move around during a multiplexing cycle. Thus, even if it were said that a parallax barrier display comprises a scanning of the liquid crystal cells, because the liquid crystal cells are turned on and off between frames, there is no scanning sequence, because the slits and barriers are static and not to move during a generation of an image by the image generating layer.

Fast operating liquid crystal cells are not necessary in a parallax barrier display, because the liquid crystal cells are alternated between only a few states during a multiplexing cycle, typically two, e.g. as mentioned above the liquid crystal cells define slit or barriers and this can be achieved with liquid crystal cells used in traditional 2D displays operating at 60 frames per second.

### US20050219693

US20050219693 discloses a specific example of a parallax barrier display. In this specific example, the barrier/aperture moves in front of an image generating layer.

For each position of the aperture, the image generating layer generates a perspective of a scene, e.g. for each position is generated a new image—each image showing a perspective of a scene. Thus, a full image is created for each position of the aperture, e.g. all pixels in the image generating layer are scanned/updated. Such a display can show a hologram, but the brightness will be low, because it is still a parallax effect that is used to achieve the depth perception.

For a “frame” which is 1/20 of a second in US20050219693, the aperture has been at 18 positions (for a non-blinking perception for an observer a frame duration should be 1/60 or more of a second, but US20050219693 cannot achieve that—the present disclosure can). At each position, the display screen generates a whole image. Each image is a perspective of a scene. Thus, 18 images are generated in each time window of 1/20 of a second. A normal display generates 1 image, and the present disclosure (the hybrid scan display) generates one image per active viewing zone.

A suitable number of aperture positions in the present disclosure would be 32. If US20050219693 had 32 aperture positions the US20050219693 display would have to generate 32 images per 1/60 of a second. That is not realistic. At present it is not even clear if it is realistic to generate 18 images per 1/60 of a second in a mass-produced display. It is so fast that such a display cannot realistically be mass-produced because the specification for the control electronics is too high, e.g. components used for mass production are not that fast. However, the present disclosure can account for that by showing the same right eye image to each right eye and the same left eye image to each left eye. This is not possible in US20050219693.

When an observer looks at the US20050219693 display, the right eye of the observer will see one part of the scene (specific perspective image generated at that aperture position) and the left eye will see another part of the scene from the angle of that aperture position—just as if the observer looked through an aperture with the real world on the opposite side of the aperture. This is simple ray tracing—the aperture will focus different parts of the image on the two eyes. As the aperture has moved through all aperture positions, the observers brain integrates the 18 parts for each eye which creates the 3D perception.

This means that the US20050219693 display cannot be used to watch a 3D movie, such as Avatar or any other 3D movie, because 3D movies do not have recordings of 18 perspectives for each frame. 3D movies only have a right eye image and a left eye image.

The US20050219693 display can also not be used as a multiview display, e.g. a display where one observer watches one movie and another observer watches another movie.

Furthermore, the brightness will decrease by a factor of 18 or more. This is also not something that happens with the present invention.

Compared to this, the disclosed display generates an image for each active viewing zone, e.g. a right eye image for a right eye and a left eye image for a left eye for example. Or a first image to an active viewing zone to the right of the display and a second image to an active viewing zone to the left of the display (images to a passenger and a chauffeur in a car for example). The images are not generated sequentially as in US20050219693, but all the images are split in parts and the parts are placed in a sequence with a part of one image being followed by a part of another image in the sequence. An analogy is that in the present disclosure it could be said that the different images are generated in parallel.

The disclosed display directs the light specifically to the active viewing zones, and nothing can be seen in the non-active viewing zones, because no light is generated for the non-active viewing zones—the display is not capable of directing light to all viewing zones.

### Summary of the Disclosed Display

The disclosed display has different components and operates in a different way than lenticular displays and parallax barrier displays.

In summary, the disclosed display comprises the following two key components:
1) A layer comprising light emitters arranged in columns (LED columns for example—there may be only one light emitter per column), where each light emitter may be driven with a high current in a low duty cycle for a very high peak pulse brightness.
2) A layer with modulators, such as liquid crystal cells, having fast response times (such as ferro-electric liquid crystal cells).

And when it comes to the control of the disclosed display, the disclosed display has two key features, e.g. the controller is arranged for controlling the display such that:
A) Each liquid crystal cell is open only a small fraction of a multiplexing cycle, such as less than or equal to 20% or 12.5% or 10% or 5% of the multiplexing cycle excluding blanking period, e.g. one liquid crystal cell is open at a time during each step in the scanning sequence of the liquid crystal cells creating an effect of a moving aperture during the multiplexing cycle.
B) Each image is divided in a number of parts, and the sequence of image parts for each image are interleaved resulting in an interleaved sequence. Thus, while one liquid crystal cell is open in a time interval (Tc), a number of steps of the multiplexing cycle takes place such that a number of LED columns are scanned non-consecutively, e.g. a plurality of non-neighbouring LED columns are selected one by one in each step for generating a light pattern, e.g. for emitting light.

For example, with two active viewing zones, such as a right eye zone and a left eye zone, two images are to be displayed, a right eye image R and a left eye image L. With five liquid crystals each image is divided into five parts: R1, R2, R3, R4, R5, L1, L2, L3 L4 and L5. The interleaved sequence IS will then be:
IS: R1, L1, R2, L2, R3, L3, R4, L4, R5, L5.

This example has a very rough horizontal resolution, e.g. only 5 pixels. The resolution may be increased either with more crystals or with an additional module. If each module has five crystals, the horizontal resolution is now ten pixels and two interleaved sequences (IS) run in parallel:
IS1: R1, L1, R2, L2, R3, L3, R4, L4, R5, L5
IS2: R6, L6, R7, L7, R8, L8, R9, L9, R10, L10

The two sequences could also be:
IS1: R1, L1, R3, L3, R5, L5, R7, L7, R9, L9
IS2: R2, L2, R4, L4, R6, L6, R8, L8, R10, L10

As is evidentm, it is important that a part of an image for one active viewing zone is followed by a part of an image for another active viewing zone. For a few number of viewing zones, the sequence may have two or three or maybe four parts from the same image following each other in the sequence before one or more parts from another image such as:
IS: R1, R2, L1, L2, R3, R4, L3, L4, R5, R5

This will require that the moving aperture moves “two” times, e.g. each crystal needs to be opened/scanned the same number of times as parts from the same image follow each other in the sequence.

Not all LED columns are scanned for emitting light, only the ones that are needed for directing light to a (active) viewing zone, e.g. as mentioned, a viewing zone/region is defined as an active viewing zone when there is an observing eye in that viewing zone. Light is not emitted to non-active viewing zones (except if the display is to operate in a multiview mode). For each active viewing zone there is a column (depending on the selected liquid crystal cell that is open) that together with the aperture results in a vertical image pattern being visible in the active viewing zone. Each image pattern corresponding to an image part (and not a whole image).

The number of times columns are “selected” (from the plurality of columns) is a function of the number of liquid crystal cells and the number of viewing zones (equals the number of cells multiplied with the number of active viewing zones. For example, with four active viewing zones and 32 cells, a total of 128 light flashes are generated in a multiplexing cycle.

The three terms scanned/updated/addressed which are used in the industry are inter-changeably used in the disclosure unless specifically explained otherwise, and the term “selecting” is to be understood as a general term for any of these three terms.

The liquid crystal cells constitute a (spatial) light modulator layer arranged as a plurality of vertically elongated light valve columns. Each liquid crystal cell is arranged as an aperture with respect to the light emitters. This means that the aperture has an optical power/focusing effect and light is focused by the aperture, and the aperture is to be fully illuminated horizontally.

### Modules

The light emitters and liquid crystal cells may be divided into logical modules, which may be controlled in parallel, e.g. the light emitters divided into in a first set of logical modules constituting a set of light emitter modules, and the light modulators divided into in a second set of logical modules constituting aperture modules.

In the following, when referring to the term “module” is meant the collection of a light emitter module and aperture module together constituting a “module”, e.g. a module comprises an aperture module in front of a light emitter module.

A small disclosed display (size of about 2 inches) may comprise only one module.

### Fast Response Times

Both the light emitters and the liquid crystal cell are thus to have fast response times (for a desired number of observers, e.g. more than two observers observing 3D content).

The very fast response times may be achieved by using a mechanically stable very fast ferroelectric liquid crystal light modulator combined with even faster light emitting diodes, operated in a multiplexing cycle where the response time requirement for the light modulator is minimized and the update frequency made possible by having a higher update frequency of the LED columns than of the liquid crystal cells. This may be achieved by the above-described key features.

The reason why the required scan rate or speed can be achieved is that only the needed LED columns for the active viewing zones are updated with pixel values—meaning that the liquid crystal cells need to be fast as well in order to create the moving aperture in a multiplexing cycle.

### Low Number of Open Liquid Crystal Cells

During a multiplexing cycle, all liquid crystal cells are opened at least one time (outside of a blanking period, cf. the description below), and each liquid crystal cell is open only a small fraction of a multiplexing cycle, e.g. one liquid crystal cell is open at a time during each step in the multiplexing cycle (it may be that one liquid crystal cell is not entirely closed before the next starts to open).

Thus, the scanning sequence of the liquid crystal cells creates an effect of an aperture moving across the LED columns during a multiplexing cycle.

### Moving Aperture

The term “moving aperture” is not to be understood literally in that there is something that physically moves. It is a new liquid crystal cell that has been open for light transmission at each step in the scan of the plurality of liquid crystal cells, but since the liquid crystal cells have different positions, the effect will be that during a multiplexing cycle, an aperture has occupied each position and it therefore looks like it has moved.

Thus, behind each open liquid crystal cell is a large number of LED columns, and the (single) open liquid crystal cell (of a module) functions as an aperture focusing the LED columns on the observers one column at a time for each viewing zone by “moving” the aperture one position at a time.

To summarize, a parallax barrier display has a high number of liquid crystal cells being open (being in a light transmitting state) and the disclosed display has a low number of liquid crystal cells being open, e.g. the opposite of a parallax barrier display. The advantage is that there are a large number of pixels behind each aperture for zero unwanted rays in a large, central viewing zone and further greatly reduced number of unwanted rays in peripheral viewing zones, hence allowing a large number of observers without or with very little artifacts.

### Pulsed LEDs

There is a disadvantage of this principle behind the disclosed display though, because the low number of open liquid crystal cells reduces the brightness of the display.

To solve that problem, the disclosed display may use pulsed light sources with a high peak pulse optical power.

Since the disclosed display has a high multiplexing ratio and corresponding multiplexing frequency conditions for operating light sources, such as LED's, in pulsed mode can be met, e.g. peak pulse duration (Tled) is below a certain threshold (such as 100 micro seconds) and multiplexing ratio is above a certain threshold (such as 30 or 100 or 200). The peak pulse brightness may be for example 5-50 times higher than a continuous brightness for certain types of LEDs, solving the brightness problem.

An LED column may be flashed in a pulse of width Tled shorter than a duration of the light valve column open time window (Tc) divided by a number of active viewing zones (viewing zones comprising an observing eye).

For example, Tc may be 260 microseconds and a number of viewing zones may be 10 hence Tled=26 microseconds.

During such a short pulse, the current through an LED may be very high, for example between 100mA and 1000mA, which we may refer to as a peak pulse current (Ip).

The image observed by an observer is time integrated on the retina of the observer's eye and its maximum brightness may be a function of the maximum peak pulse brightness, the pulse width Tled and a number of pulses per duty cycle. The pulse width of an LED and the number of pulses per duty cycle may be defined as described above for the general operation of the display, hence may be restricted.

The pulsing of the LEDs is relevant for both organic (OLED) as well as inorganic LEDs, such as microLEDs.

In other words, pulsed operation may be defined as, in an interval in which an aperture is open, operating an LED outside of a condition suitable for sustained operation and, after that interval, including a recovery interval, in which the LED may recover. In the present disclosure, such operation may be synchronized with the scanning of apertures for achieving more brightness and/or better LED performance, including longer lifetime.

### Example of Time Intervals

For example, the disclosed display may have a frame rate of 60 frames per second resulting in a duty cycle duration of a multiplexing cycle of (Tm)=1000/60 milli seconds=16.7 ms.

A 50% blanking period may be used for maintaining a DC balance of the liquid crystal cells. Alternatively, DC balance may be maintained through voltage time product balancing.

The time interval in which a liquid crystal cell is open (either with or without transition time) is in the present disclosure referred to as (Tc).

With (Nc)=32 liquid crystal cells and (Nz)=ten viewing zones a liquid crystal cell may then be open in a time interval (Tm)/(Nc)*0.5=16.7/32*0.5=0.26 ms including transition time (the time it takes for a liquid crystal cell to transit from a fully closed state to an fully open state).

If it is assumed there is a 0.05 ms transition time for turning a liquid crystal cell on (open) and off (closed) a liquid crystal cell is (fully) open in a time interval 0.26−2×0.05=0.16 ms.

For optimization, the next liquid crystal cell in the sequence can begin to open some time before the previous has closed, for example this time can be a function of the transition time (for example be equal to), e.g. the next liquid crystal cell can begin to open/be addressed/scanned 0.05 ms before the previous liquid crystal cell in the scanning sequence closes.

The time interval in which a liquid crystal cell is open including transition time may be used to define the (maximum) pulse width of an LED. Thus, as an example of a maximum pulse duration/width the LED pulse duration including pre-charge is then (Tled)=(Tc)/(Nz)=0.16 ms/10=16 microsecond (us). A maximum pulse duration may correspond to a maximum brightness when using pulse width modulation, e.g. if the brightness value of a pixel is 50% of the maximum brightness, the pulse duration is 50% of the maximum pulse duration.

The LED duty cycle is then (Tled)/(Tm)=16 us/16.7 ms=0.0958% (at maximum brightness).

A duty cycle is defined as the ratio of time a load or circuit is ON compared to the total time, e.g. Tₒₙ/(Tₒₙ+T_{off}).

### Multiplexing Cycle

The display uses a so-called multiplexing scheme for generating the images to each active viewing zone.

In this scheme, each image is divided into parts, e.g. a sequence of image parts/elements is made, and the display then generates the parts one after the other one step at a time in the sequence. This is referred to as a multiplexing cycle.

Specifically, in each step of the multiplexing cycle pixel values are provided in data lines connected to the LEDs in each column, and a specific column is selected by a “select signal” on a select line.

Thus, in a specific step an LED column is selected such that it emits a light pattern according to the pixel values provided by the data lines. The sequence of the multiplexing cycle can be said to be the order of the columns that are to be scanned.

### Interleaved Sequence

For the disclosed display the sequences of image parts for each image to be displayed in each viewing zone are preferably interleaved resulting in an interleaved sequence, e.g. the image parts of the different images are inserted in between each other—each element of the interleaved sequence is an image part (a single column of pixel values).

The interleaved sequence alternates between image parts from different images, e.g. the interleaved sequence does not have two consecutively (one after another without interruption) elements from the same image.

For example, for two observers, the resulting interleaved sequence has as first element a first part of a first image for a right eye of observer 1. The second element is a first part of a second image for a left eye of observer 1. The third element is a first part of a third image for a right eye of observer 2. The fourth element is a first part of a fourth image for a left eye of observer 2. These first four elements correspond to the first four steps in the multiplexing cycle, e.g. in the first four steps the four image parts are generated, e.g. the first image part of each of the four images. The elements of the interleaved sequence do not have to be in any specific order. As will be explained later, all image parts can be generated in parallel or they can be generated in a random order.

The fifth element of the interleaved sequence is a second part of the first image, and the sixth element is a second part of the second image and so forth.

The first parts of each image are generated when a first liquid crystal cell opens, and when the first parts have been generated/displayed, the first liquid crystal cell is closed and a second liquid crystal cell is opened and the second parts of each image may be generated/displayed.

### Single Image Part

For the disclosed display, each image is divided into a number of parts, e.g. a part for each (single) pixel column of the image.

This single image part of an image is then generated/displayed when a liquid crystal cell is in the light transmitting state, and the LED column emitting a light pattern defined by a respective single image part in each step of the multiplexing cycle—a plurality of single images parts is generated (one for each image) when a specific liquid crystal cell is open.

Since there may be a number of modules as mentioned below, there may be displayed one image part per module. So if there are for example 60 modules, there will be displayed 60 parts of an image in total at each step in the multiplexing cycle.

### Number of Modules

If the images to be displayed have a horizontal resolution of 1920 (pixel columns), which is a typical resolution in the industry, and a preferred number of liquid crystal cells is 32 the number of modules of the disclosed display is 1920/32=60.

Each module is then responsible for displaying 1/60 of an image.

At each step of the multiplexing cycle are emitted 32 light patterns for an active viewing zone. Thus, the 1/60 of an image that a module is responsible for is divided into 32 parts, e.g. resulting in 32*60=1920 image parts. At a given time, e.g. on average, 60 parts are displayed more or less in parallel, e.g. one part per module. To summarize, 60 apertures will move across the aperture layer (one aperture per module).

### Multiplexing Ratio

The multiplexing ratio is the number of steps in the multiplexing cycle, and each step in the multiplexing cycle lasts a time interval of (Tm) as mentioned, e.g. it is the length of the sequence excluding a blanking period.

Using the same example of 32 liquid crystal cells and 10 active viewing zones, the multiplexing ratio is 32*10=320.

### Sub-Sequences

One thing that is desired when it comes to the interleaved sequence is that it comprises “sub-sequences” defining the scanning sequence of the LED columns that are to be scanned/updated with pixel values and emit a light pattern when a liquid crystal cell is open.

Specifically, it is desired that a sub-sequence only comprises elements image parts for different images, such that an image part for each image is generated during a sub-sequence scanning (with generated is meant emitting a light pattern transmitted through the aperture and observed by an eye in an active viewing zone).

Thus, a first sub-sequence has only elements that are image parts from each of the images—there is no sub sequence that has two elements that each are an image part from the same image.

A sub-sequence of the multiplexing cycle is a function of the liquid crystal cell being open (at a step in the scan sequence of the liquid crystal cells) and the active viewing zones.

Such sequences and dependency do not exist in a parallax barrier display where the scan sequence of the image generating layer is independent of the control or scanning sequence of the liquid crystal cells, e.g. in a parallax barrier display, one image at a time is generated or at the same time depending on the variant. However, doing that in the disclosed display would not work, because this would require all LED columns to be scanned during the time interval (Tc), e.g. during the time a liquid crystal cell is open. Instead, only LED columns for active viewing zones are selected/scanned during the time a liquid crystal cell is open.

### Avoiding “Jumping” Liquid Crystal Cells

The reason for this is to have to avoid to “jump” to another liquid crystal cell and open that during a sub-sequence, e.g. as mentioned, it is desired that each liquid crystal cell is only open once—if not the speed of the liquid crystal cells would have to be increased.

There can be an exception to this, e.g. it cannot be ruled out that an interleaved sequence is made by the controller, such that there is a jump back and forth to the same liquid crystal cell, such that the same liquid crystal cell has been open more than once during the multiplexing cycle. This can be due to avoid view crash for example. This is also the reason that it is desired that each liquid crystal cell being open (in the light transmitting state) less than a percentage (such as less than 12.5%) of the duration of the multiplexing cycle.

### Pause Between Scans of the Same LED Column

The peak pulse current (Ip) defines a peak pulse brightness of an LED, and it is therefore desirable to maximize the peak pulse current.

The maximum peak pulse current may be defined by characteristics of an LED, such as a maximum allowable junction temperate, and/or thermal resistance, and/or of a dark interval/pause following a pulse before the (same) LED is pulsed (flashed) again. The longer the dark interval, the higher the maximum peak pulse brightness.

However, the order of flashing LED columns (order in a sub-sequence) during a light valve time window (Tc) may as mentioned be selected in many different ways.

The order of scanning light valve columns (liquid crystal cells) may also be selected in many different ways without affecting the perceived images by observers.

Hence, the dark interval between pulses of a specific LED may be maximized meaning that the LED's maximum radiation/light emission may be maximized by selecting the order of flashing/scanned LED columns and/or the order of scanning the light valves.

Specifically, the display defines a first sub-sequence determining the order of LED columns (or set of neighboring LED columns) to be scanned when a first liquid crystal cell being is open, e.g. the timely order in which the active viewing zones are to receive image parts.

For the subsequent liquid crystal cell (when it opens) is defined a second sub-sequence.

It may be that the two sub-sequences define that the same LED column is to be flashed when the first liquid crystal cell is open and when the subsequent liquid crystal cell is open.

It is to be avoided that this same LED column is flashed two times in a row—or that it is flashed with a pause (between flashes) that is too small.

This can be avoided by defining for example the second sub-sequence as a function of the first sub-sequence or the other way around.

For example, if a first LED column is flashed as the last LED column in the first sequence, it should not be flashed as the first LED column in the second sub-sequence—a number (Nmin) of other LED columns should be flashed in between a particular LED column is flashed such that it has a pause.

Nmin may for example be at least one. Alternatively, Nmin may be between 1 or a number equal the number of viewing zones comprising an observing eye minus 1. For example, if the number of observers is 5, there may be 10 viewing zones comprising observing eyes hence Nmin may be between 1 and 9.

It may be that there has to be some balance between how long a pause can be and view crashes, e.g. for a specific sub-sequence defined to have a long pause that specific sub-sequence will introduce a view crash.

Thus, the second sub-sequence may be a function of maximizing a pause and minimizing view crash.

In addition to or as an alternative, the scan sequence of light valve columns may be selected to increase Nmin—it may be that for example that it is not possible to change the second sub-sequence without introducing a view crash. Changing the scan sequence of liquid crystal cells may achieve that there will be a pause and minimize or avoid view crash.

For example, a light valve scanning sequence may be selected so a first light valve is opened during which LED columns are flashed (according to a first sub-sequence) and after that a second light valve is opened during which LED columns are flashed and the first and the second light valve may be selected so there are no LED column being scanned twice when these two liquid crystal cells are open.

Further, the scan sequence may be selected so a third light valve is opened during which LED columns are flashed. The third light valve selected, so there are no LED columns being scanned twice when these three liquid crystal cells are open. This principle can be extended to a larger number of light valves being selected in a similar way, depending on the processing power of the controller.

A maximum Peak Pulse Current may be found experimentally for an LED which may be pulsed with a dark interval corresponding to Nmin of other LEDs being pulsed in between and where a Peak Pulse current is gradually increased until a critical (maximum) junction temperature for the LED is reached.

A specified maximum junction temperature may be provided by a manufacturer of the LED.

Since it may be difficult to directly measure the junction temperature during a short peak pulse, this may be found indirectly by monitoring a voltage drop over the LED.

A correspondence function between voltage drop and junction temperature may be provided by an LED manufacturer or found experimentally by measuring junction temperature, for example with an infrared thermometer over longer periods of time than a peak pulse duration.

### Frequency

The liquid crystal cells are scanned in a sequence at a frequency F(LC) being a function of the frame rate (how many images an observer is to view per second, e.g. frames per second, fps) and the number of liquid crystal cells, specifically the frame rate multiplied with the number of liquid crystals, for example with 60 frames per second and 32 liquid crystals this gives F(LC)=60×32=1920 Hz.

The light emitters (LED columns) are scanned at a frequency F(LED) being a function of the scan frequency of the liquid crystal cells F(LC) and the number of viewing zones, specifically the scan frequency of the liquid crystal cells F(LC) multiplied with the number of viewing zones. If there are ten viewing zones, this gives F(LED)=1920×10=19200 Hz. It is understood that light emitters may further be modulated for brightness by pulse width and/or pulse amplitude modulation.

### Fully Illuminated Aperture

As mentioned, it is preferred that LED columns are selected/scanned one by one in each step of the multiplexing cycle for generating a light pattern, e.g. for emitting light. Thus, one (a single) light pattern is generated at a time (passive matrix addressing) at each step.

With the term “single” is meant that the light pattern is for a single part of an image, e.g. a single image part is generated in each step of the multiplexing cycle by selecting a single column (or a set of neighbour columns emitting the same light pattern).

However, the special multiplexing cycle of the disclosed display introduces a problem of an irregular pixel pattern of the observed image.

This problem may be solved by arranging the display such that the (single) light pattern that is generated in each step is delimited by liquid crystal cells adjacent the liquid crystal cell that is open, such that only a part of the light rays of the (single) light pattern having a line of sight to the active viewing zone actually reaches this zone, e.g. had the neighboring liquid crystal cells not been closed, more light rays (of the single light pattern) would have been received by the observer's eye.

For example, it could be that the beam width (at a threshold such as at 3 dB) of the irradiated light is wider than the aperture (liquid crystal cell that is open)—it may only be slightly wider, but the beam width is not to be narrower than the aperture.

With a line of sight is meant a line from an observer's eye to a distant point (the LED column or diffuser in front of the LED column). Thus, part of what the observer would see if the neighboring liquid crystal cells, which has not been closed, is blocked by these closed neighboring liquid crystal cells.

Ray tracing software may be used in the design phase of the display to determine if the outermost light rays to the left and to the right of a set of LED columns flashing light at a step in a scan sequence are delimited by the aperture. If this is the case, the aperture is completely illuminated. It is not necessary in a parallax barrier display for each slit to be completely illuminated, because all slits for a viewing zone are open at the same which means that no black vertical stripes will appear.

Since there is darkness at each side of a LED column emitting light and only one column at a time emits light, there would be formed a Moiree pattern visible to the observer if there was no such delimitation, e.g. an observer would see a repeated pattern of dark stripes and this repetition (seen through apertures) gives rise to the Moiree pattern. As a result, the image quality would be reduced.

US20050219693 discloses that the pixel width is defined by the image generating layer and contrary to the disclosed invention US20050219693 would have a Moiree pattern if it were not for the fact that an entire image is generated at each step in US20050219693.

### Liquid Crystal Cells Define the Position of Pixels in the Horizontal Plane

The above has the consequence that it is the liquid crystal cells that define the horizontal pixel positions of the image observed in an active viewing zone, e.g. it is not the LED columns that define the horizontal pixel position of the observed image—this is opposite to for example parallax barrier displays.

### Set of Columns

A specific solution for illuminating the aperture fully could be to select a set of neighboring LED columns in each step of the multiplexing cycle making the light pattern “wider”. The set may comprise for example two neighboring LED columns. In the example in the drawings three are illustrated.

Specifically, the set of columns are updated with the same pixel data values at each data line and the switch for each column in the set of columns are then selected and switched on, thereby establishing a parallel connection of the LEDs in the set of columns, and the LEDs are driven at a current which corresponds to the normal driving current multiplied with the number of columns in the set.

A parallel connection of LEDs is normally a problem since LEDs do normally not have the same forward voltage, but in this case, each column in the set is to emit the same light pattern and the LEDs are driven at high voltages.

A set of columns may comprise between 1 and 10 columns, preferably 2 or 3 or 4 columns.

### Diffuser

Another specific solution for illuminating the aperture fully could be to have a diffuser for diffusing light horizontally and placing it between the LED layer and the liquid crystal cells, e.g. the diffuser may be a horizontal diffuser—diffusing more light in the horizontal plane than in a vertical plane.

If a diffuser was added to the display disclosed in US20050219693, the image would become blurred, because light from neighbouring pixel columns would be mixed by the diffuser.

Both the solution with a set of columns and the diffuser may be combined.

### Auto-Stereoscopic Display

A display operating as an auto-stereoscopic or multi-view display is per definition arranged to direct an image to a viewing zone in front of the display so that the image can only be observed in that specific viewing zone. In this way, a pair of two-dimensional images may be directed to an observer's eyes who perceives a depth in the image, e.g. the display may direct a first image to the position of the right eye of the observer and direct a second image to the position of the left eye of the observer so that each eye sees a different image. In this case, a first viewing zone corresponds to a first eye of the observer and a second viewing zone corresponds to a second eye of the observer.

Alternatively, in the situation when the display is functioning as a multi-view 2D display, a first observer at a first position in front of the display may see a first 2D image and a second observer at a second position in front of the display may see a second 2D image. In this case, a first viewing zone may correspond to the face of the first observer and a second viewing zone may correspond to the face of the second observer.

### A First Aspect of the Present Disclosure is:

A hybrid scan display (for emitting light to a plurality of active viewing zones including a first active viewing zone and a second active viewing zone) comprising:
a plurality of light emitters for emitting light,
a plurality of liquid crystal cells,
each liquid crystal cell arranged for switching between two states including a light transmitting state for transmitting light from said plurality of light emitters or a light shielding state for shielding light from said plurality of light emitters.

### A Second Aspect of the Present Disclosure is:

A method for emitting light to a plurality of active viewing zones including a first active viewing zone and a second active viewing zone by means of a hybrid scan display, said hybrid scan display including:
a plurality of light emitters for emitting light,
a plurality of liquid crystal cells,
each liquid crystal cell arranged for switching between two states including a light transmitting state for transmitting light from said plurality of light emitters or a light shielding state for shielding light from said plurality of light emitters,
said method comprising providing said hybrid scan display and emitting light by means of said light emitters and switching said liquid crystal cells for directing light to said plurality of active viewing zones.

### A Third Aspect of the Present Disclosure is:

A hybrid scan display for emitting light to a plurality of active viewing zones including a first active viewing zone and a second active viewing zone, said display comprising:
an LCD panel for generating a first image and a second image during a multiplexing cycle, and
a backlight for emitting light towards said LCD panel,
said backlight including:
a plurality of vertical arranged light guides positioned behind said LCD panel,
a plurality of light emitters, each light guide being illuminated by a light emitter,
a plurality of liquid crystal cells positioned between said plurality of light guides and said LCD panel,
each liquid crystal cell switching between two states including a light transmitting state for transmitting light from said plurality of light guides, or a light shielding state for shielding light from said plurality of light guides,
a controller for scanning said plurality of liquid crystal cells, such that each liquid crystal cell having been open once creating an effect of a moving aperture during said multiplexing cycle,
said plurality of light emitters scanned one after another in a sequence being a function of said moving aperture and alternating between said backlight emitting a first light flash visible at said first active viewing zone, and a second light flash visible at said second active viewing zone,
said LCD panel being synchronized with said backlight, such that said LCD panel generates a part of said first image when said backlight emits said first light flash and said LCD panel generates a part of said second image when said backlight emits said second light flash.

With the term “generating” is meant producing or creating, e.g. with generating an image is meant that the image pattern of the image file is produced, such that it may become visible to an observer (when backlight is applied in the case of LCD). And generating light means that light is produced such that light is emitted.

With “two states” is meant that the cells are preferably binarily operated, e.g. with binary “mode” is meant that the liquid crystal cells exclusively have the two mentioned states (light transmitting state and a light shielding state). The cells are not operated in a grey scale mode, e.g. having a plurality of states with different grey values (light transmission). Said in other words, a cell is either 100% open or 100% closed—or as close to 100% as possible depending on manufacturing tolerances (liquid crystals are known to have some light transmission even when being closed).

As mentioned, the display may comprise a plurality of modules where each module is arranged as above, e.g. a plurality of light emitters for emitting light, said plurality of light emitters preferably being arranged in columns, and a plurality of liquid crystal cells, each liquid crystal cell switching between two states including a light transmitting state for transmitting light from said plurality of light emitters, or a light shielding state for shielding light from said plurality of light emitters.

The display may also only have one (a single module), but that would be a small display (such as two inches) or a display with low resolution.

The modules may be controlled in parallel by a controller. There may be a dependency between the control of two or more modules.

Each module may be controlled according to the below.

The controller may scan the plurality of liquid crystal cells in a sequence such that each liquid crystal cell having been open once creates an effect of a moving aperture during a multiplexing cycle.

The controller may be arranged for scanning the columns and the plurality of liquid crystal cells during the multiplexing cycle for displaying a plurality of images,
each image divided into a sequence of image parts,
each image part constituting a single column of pixels of said image,
the plurality of sequences of image parts being interleaved into an interleaved sequence (defining the multiplexing ratio excluding a blanking period).

A single image part of an image is displayed when a liquid crystal cell is in the light transmitting state, and a respective column emits a light pattern defined by a respective single image part in each step in the multiplexing cycle. One single image part for each image to be displayed may be generated when a liquid crystal cell is open.

Said in other words, the number of columns (of light emitters) that may be scanned when each liquid crystal cell is in the light transmitting state is greater than one and less than the (total) number of columns, e.g. preferably the number of columns (=the length of a sub-sequence) is equal to the number of active viewing zones—not withstanding any “don't care” columns that may be scanned for various reasons (a don't care column is a column that generates a light pattern not visible in any of the active viewing zones).

The display may be arranged such that the light pattern emitted by a column is delimited by liquid crystal cells adjacent the moving aperture such that only a part of the light rays of the light pattern having a line of sight to the first active viewing zone reaching the first active viewing zone.

The controller may select vertical columns during a multiplexing cycle,
a first vertical column selected as a function of a liquid crystal cell being in a light transmitting state and a first active viewing region, and
a second vertical column selected as a function of said liquid crystal cell being in a light transmitting state and a second viewing region.

Each liquid crystal cell being in said light transmitting state less than 25%, such as less than 20% or 15% or 10% or 5% of said multiplexing cycle.

The display may have a vertical pixel resolution being a function of the number of light emitters in a vertical column, and each individual pixel defined in width by the width of a liquid crystal cell.

The display may have a vertical pixel resolution being a function of the number of light emitters in a vertical column, and
having a horizontal pixel resolution being a function of the number of liquid crystal cells of said plurality of liquid crystal cells (multiplied with the number of modules when the display has more than one module).

The display may have a vertical pixel resolution equal to the number of light emitters of a specific color in a vertical column.

The display may have a horizontal pixel resolution equal to the number of liquid crystal cells of said plurality of liquid crystal cells (multiplied with the number of modules when the display has more than one module).

A pixel of the display may be defined in width by the width of a liquid crystal cell and in height by the height of the light emitting area of a light emitter.

The term “function of” means that something is dependent on each other, e.g. x being a function of y means that x depends on y, e.g. has a value or state that depends in the value or state of y.

It is the light emitters that are responsible for generating the light patterns that in the end leads to an image/contents that the display is to display to observers, e.g. a digital image is input to the display, which then reads the pixel values of the image file and generates the contents based on that.

The light emitters may be light emitting diodes, such as microLEDs (array of microscopic LEDs forming the individual pixel elements), or OLED or an LCD+backlight. These are all known display types used to generate contents. In the present disclosure the terms “light emitters” and “light emitting diodes” may be interchanged.

The light emitters may be arranged in vertical columns. In the present disclosure this may be referred to as “LED columns” or “vertical columns of LEDs” or “light emitter columns”.

The term “liquid crystal cells may be interchanged with the terms “spatial light modulators” or “vertically elongated light valve columns” or “ferro-electric liquid crystal cells” or “LCD layer”. The liquid crystal cells may be arranged in a layer.

A light transmitting state may also be referred to as an open state, e.g. a liquid crystal cell being open (for light transmission).

The light emitting diodes by themselves or together with a diffuser may constitute a light spreader for emitting columns of light onto the LCD layer, e.g. one or more columns of light emitting diodes (set of LED columns) may be used to illuminate the LCD layer or alternatively, a single LED column may illuminate a diffuser, which in turns spreads the light onto the LCD layer.

The reason for this is that compared to a parallax barrier display, it is important that the light is delimited by the aperture, e.g. the whole width of an aperture has to be illuminated in order for the aperture to have an optical power/focusing effect.

Said in other words, the part of the LCD layer that is illuminated by the light spreader may be wider than the width of an aperture, e.g. the aperture blocks some of the light from the light spreader. In order to ensure this, more than one column of LEDs may flash light at the same time (in the case no diffuser is used).

Directional light emitters may be constituted by light emitting diodes with an optical element having an optical power (such as a lens) in front of each LED, such that the display may have a vertical resolution of viewing zones, e.g. for each pixel there may be two directional light emitters, one for directing light downwards and one for directing light upwards. In this way, the display may direct an image towards observers sitting at the floor in front of the display and observers sitting on a couch in front of the display.

The plurality of liquid crystal cells could be said to constitute a moving lens, e.g. correspond to a single lens that is moved across the LEDs as explained above. This means that the whole aperture (liquid crystal cell in the light transmitting state) needs to be illuminated. Thus, it may be necessary to flash two adjacent LED columns (set of LED columns). It may also depend on the observer, e.g. if the observer is for example very close to the display relative to the distance between the vertical LED columns/arrays and the liquid crystal cells. This may also ensure an even light distribution independent of the observer distance to the display.

This is also different from how a parallax barrier display operates, because in that type of display the control of the barrier pattern is static, e.g. it has a fixed striped pattern, for example all even columns are open during the generation of a right eye image and all uneven columns being open during the generation of a left eye image.

If the light emitting diodes are OLEDs, the light emission is from a whole layer and not discrete emitters like inorganic LEDs. In this case, the radiation pattern may be controlled by how wide a part of the OLED layer is addressed in order to illuminate an aperture.

In any case, a diffuser may be placed between the light emitters and the liquid crystal cells. This may achieve that the light intensity of each liquid crystal cell has a (horizontal) brightness centroid substantially at the centre of each liquid crystal cell when light is transmitted. Substantially meaning within production tolerances of a diffuser, such that the position of the brightness centroid does not deviate from the centre with more than 20% relative to the width of a liquid crystal cell.

The (horizontal) brightness centroid is the “centre of gravity” of the light transmitted through a ferro-electric liquid crystal cell in a horizontal plane.

The (horizontal) brightness centroid may be defined as follows: at a given height of a ferro-electric liquid crystal cell, the brightness centroid is the weighted mean of all points across a ferro-electric liquid crystal cell (from left to right or vice versa) weighted by the specific light intensity of each point.

As an alternative to the diffuser, the display may be configured such that each liquid crystal cell having a light intensity that is a function of the position of the brightness centroid in a horizontal plane of the liquid crystal cell and two pixels of said digital image, e.g. firstly the position of the brightness centroid in a horizontal plane of the liquid crystal cell is determined, then it is determined where in the digital image this position corresponds to. If this position in the digital image is between two pixels, an “artificial” pixel value is determined by interpolating between these two pixel values, such as determining an average value between the two pixel values. The LED that is to emit light then emits a light intensity equal to the artificial pixel value.

For example, one pixel value may be one and the other pixel value may be 0. The artificial pixel value is then determined as 0.5.

When observing the display from a distance, this “re-sampling” or interpolation of the digital image compensates for the fact that the observer is at a position where the brightness centroid of a ferro-electric liquid crystal cell is not aligned with a pixel in the digital image. If this compensation was not carried out, the image would appear smudged. In praxis the diffuser does the same thing, e.g. the re-sampling may be done by an algorithm or by a diffuser.

In the case of inorganic or discrete LEDs, they may be placed at a distance horizontally such that two neighbouring LEDs are closer to each other than the width of the beam of light that one LED irradiates onto the liquid crystal cells, e.g. the beam width of the radiation pattern at the liquid crystal layer. Thus, the pitch between LED columns are smaller than the beam width of the radiation pattern at the liquid crystal layer. The beam width may be at 3 dB for example.

Liquid crystal cells are typically sandwiched between a pair of electrodes implemented as glass substrate layers.

There may be a second layer/plurality of liquid crystal cells, e.g. two layers of liquid crystal cells arranged next to each other (one layer arranged between the LEDs and the other layer of liquid crystal cells). This may reduce light leaking through the liquid crystal cells, e.g. if light is leaked another observer than the intended observer may see artifacts on the display similar to cross talk between images.

During a multiplexing cycle (“cycle”), an image/frame has been generated to each viewing zone, for example a right eye image to a right eye viewing zone and a left eye image to a left eye viewing zone in the case of a single observer observing in 3D mode.

During a multiplexing cycle, all liquid crystal cells have been open, but only a percentage of the liquid crystal cells are open at a time, e.g. only a percentage of the total number of liquid crystal cells are open at the same point in time. The percentage may be less than 25%, such as less than 20% or 15% or 12.5% or 10% or 5%. In the example below one liquid crystal cell is open at a time (1 out of 32=3.1%), but it may be more than one (but less than the percentage) for taking into account that one liquid crystal cell may be open while another has initiated an opening.

During a multiplexing cycle the display is scanned/addressed, such that one after the other of liquid crystal cells are opened, e.g. the liquid crystal cells are opened sequentially, e.g. in a sequence (from left to right or from right to left—another scan sequence may be used as long as all liquid crystal cells are scanned in the multiplexing cycle). Otherwise, the aperture would not move across the display.

Thus, a (light) signal is transmitted through each liquid crystal cell to an observer's eye (for 3D)—one light signal for each liquid crystal cell that is scanned in the multiplexing cycle. For each eye, the brain of the observer then multiplexes/integrates these signals to form a perceived image (which is why it is called multiplexing). If there are 32 liquid crystal cells the brain integrates 32 light patterns/signals. The left eye image and right eye image are then integrated by the brain to perceive a 3D image. This will be the case for all observers.

For each liquid crystal cell that is open are scanned a number of vertical columns of LEDs non-sequentially depending on the number of viewing zones (at least two viewing zones), e.g. one vertical column (of LEDs) is scanned/addressed per viewing zone when a respective ferro-electric liquid crystal cell is open.

So the images for all viewing zones during a cycle may be generated by sequentially scanning the liquid crystal cells one by one and sequentially scanning a number of vertical columns per ferro-electric liquid crystal cell.

In an example of one observer observing 3D content, two vertical columns of LEDs are scanned each time one ferro-electric liquid crystal cell is scanned/addressed.

For a passive matrix addressing scheme the vertical columns are scanned one by one after each other.

In an active matrix addressing scheme, the vertical columns may be scanned such that they stop emitting light substantially at the same time, e.g. there is a time window in which all the vertical columns emit light at the same time—they may be addressed one by one, but be driven by a driver circuit having a memory component, such that a vertical column emits light for longer time than in a passive matrix addressing scheme and there is a time overlap in which all of them emit light.

If there are two observers observing different 3D content/images, four vertical columns of LEDs are scanned each time one ferro-electric liquid crystal cell is scanned/addressed. However, the same content may be displayed to each observer, in this way the vertical columns may be scanned in pairs, e.g. two vertical columns scanned at the same time for flashing light before moving on to the next two vertical columns.

The ferro-electric liquid crystal cells may be scanned independent from any viewing zone (or direction to viewing zone), e.g. the controller selects a ferro-electric liquid crystal cell to be scanned, and the column of LED to be scanned is then determined as a function of the selected ferro-electric liquid crystal cell and the viewing zone before the controller proceeds to the next ferro-electric liquid crystal cell that is to be scanned.

The vertical columns of LEDs are scanned dependent (as a function) of the number of viewing zones and the direction to each viewing zone. Which specific vertical columns that are to be scanned when a specific ferro-electric liquid crystal cell is open depends on the direction to the respective viewing zone.

With scanning is meant addressing of relevant elements for generating the image for a respective viewing zone, both the ferro-electric liquid crystal cells and vertical columns of LEDs are scanned. The ferro-electric liquid crystal cells are scanned in order to open one by one and the vertical columns of LED are scanned in order to flash light, e.g. during the scan, the ferro-electric liquid crystal cells are addressed one after the other such that a ferro-electric liquid crystal cell that has been addressed opens for light transmission and the LEDs of a vertical column of LEDs are addressed one by one, such that a vertical LED column that has been addressed emits light.

Eye tracking/observer tracking may be used to determine where in space the image is to be directed, e.g. the tracking may determine the direction to (or position of) a respective viewing zone. A camera may be used for the tracking.

A viewing zone may be the size of an eye, or it may be as large as the face of an observer. There may be only two viewing zones, such that one viewing zone is to the right of the normal vector to the display surface and the other is to the left of the normal vector to the display surface, such a use case may for example be the infotainment screen in an automobile.

The vertical columns of LEDs are flashed in order to have as high light intensity as possible, because the apertures/ferro-electric liquid crystal cells in front of the vertical columns of LEDs block some of the light, thereby reducing the light intensity from the display. This is inevitable, because the liquid crystal cells are set up to function as apertures (and not slits). The flashing may also increase the number of viewing zones.

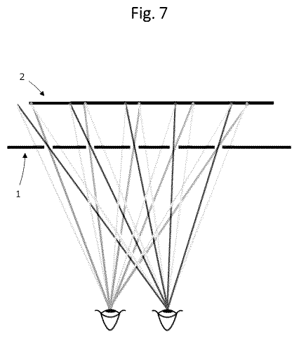

The modules may also be called segments, and each module may be identical to the display according to the above aspect(s). As mentioned, it is not necessarily to be understood as physical segments, but logical segments, e.g. the controller controls the segments in parallel. This is explained further in connection with FIG. 7.

For example, there may be four modules (next to each other), such that the image is split in four zones and each module being responsible for generating a fourth of the image.

The number of modules may also be defined by the controller (preferably as a function of active viewing zones/observers). For example, the number of observers and/or directions to observers may be such that the display is split in two “modules” arranged next to each other horizontally. This may increase the number of directions/viewing zones. The two modules may then be scanned in parallel such that overall, two apertures are open at the same time—one in each module. The width of a module may be a function of the number of viewing zones.

An image pixel is defined in the width (horizontally) by the width of an aperture (ferro-electric liquid crystal cell) and in the height (vertically) by a light emitting diode in the vertical columns of LEDs (if a diffuser is between the two the height will be a bit higher).

Thus, the vertical resolution of the display is a function of the number of light emitters in a vertical column, e.g. the vertical resolution of the display is equal to the number of light emitters in a vertical column—notwithstanding subpixels if the display is a color display where the color is generated for example by three subpixels (red, green and blue). However, a color may also be generated by a stacked microLED.

The horizontal resolution equals the number of apertures. This is also contrary to a parallax barrier, where the barriers do not determine the resolution of the display.

In the following, specific examples according to aspects of the present disclosure will be explained in more detail with reference to the accompanying drawings. The present disclosure may, however, be embodied in different forms than depicted below, and should not be construed as limited to any examples set forth herein. Rather, any examples are provided so that the disclosure will be thorough and complete, and will fully convey the scope of the invention to those skilled in the art. Like reference numerals refer to like elements throughout. Like elements will, thus, not be described in detail with respect to the description of each figure.

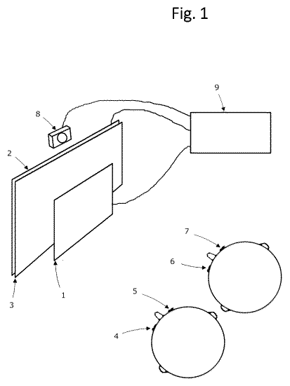

FIG. 1 shows a perspective view of an example configuration of the disclosed autostereoscopic or multi-view display.

A spatial light modulator (layer of liquid crystal cells) 1 is located in the optical axis between an LED array 2 (layer of light emitters, such as an OLED layer or inorganic LEDs) and a first observing eye 4. The distance between the LED layer and the layer of liquid crystal cells may be 40 mm.

A diffuser 3 may be comprised, located between the light modulator 1 and the LED array 2.

Further, a face tracking system 8 capable of tracking the position of the observing (eye) 4 and a controller 9 are comprised.

The controller may be connected to the face tracking system 8, to the LED array 2 and to the light modulator 1 and may be capable of receiving from the eye tracking system 8 a position of the first observing eye 4 and controlling the operation of the spatial light modulator 1 and the LED array 2 so a first image is visible in a first viewing zone comprising the first observing eye 4 and not visible in a second viewing zone comprising a second observing eye 5.

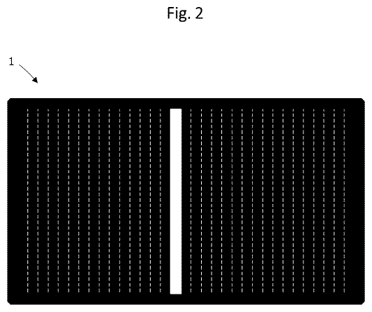

FIG. 2 shows a front view of an example configuration of the spatial light modulator 1.

The spatial light modulator 1 may comprise a plurality of vertically elongated light valve columns (liquid crystal cell, such as a ferro-electric liquid crystal cell) capable of binary operation with a fast response time, so the light valve columns can switch quickly between an open, essentially clear state having a high light transmission (light transmitting state) and a closed, essentially opaque state having a low light transmission (light shielding state). It may not necessarily be possible to achieve a light transmission of 0% in the light shielding, e.g. for example LCD displays are known to have a small percentage of light transmission even when the liquid crystals are supposed to block light.

A number Nc of light valve columns (apertures/slits) may be comprised in the light modulator 1, where Nc may be for example 32, such as more than 2, or more than 5 or 10 or 20 such as in the range 3 to 50 such as 10 to 40 such as 20 to 40.

The light valve columns may be arranged side by side as shown in FIG. 2.

The dotted lines indicate outlines of the light valve columns. A light valve column may for example be one millimetre wide and 25 millimetre high and the gap between light valve columns may be minimized and may be for example 0.05 millimetre.

A light valve column may comprise a liquid crystal cell, such as a ferro-electric liquid crystal cell, and may have two polarisers configured according to WO2022057738A1 (Application PCT/CN2021/117681), which is hereby incorporated in the description by reference.

In one example, configuration light valve columns are polarity sensitive and the controller 9 is capable of directing a light valve column to open by applying a voltage of a first polarity over a liquid crystal cell comprised in the light valve column and of directing the light valve column to close by reversing the polarity.

In another example, configuration of the light valve columns are essentially polarity insensitive and the controller 9 is capable of setting a light valve column to either closed or open by applying a voltage of any polarity over the cell and of reversing the cells state by applying zero Volt or a low voltage.

In FIG. 2, the light modulator 1 is shown with one light valve column open and the other light valve columns closed, hence the open light valve column will form an aperture capable of focusing in the horizontal direction a (vertical) light pattern generated by the LED array 2 towards the first observing eye 4.

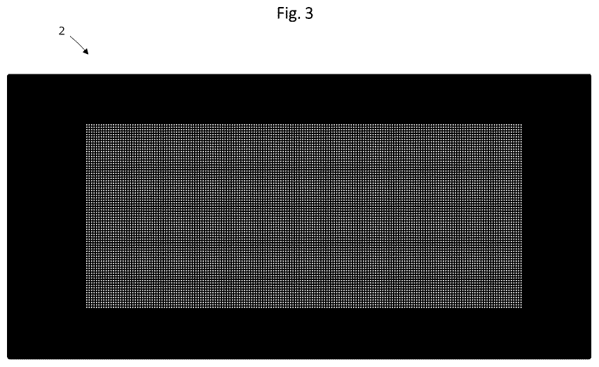

FIG. 3 shows a front view of an example configuration of the led array 2.

It may comprise for example a matrix of 210×90 LEDs with a horizontal and vertical pitch, e.g. centre to centre distances (LED pitch), of 0.5 millimetre.

With a LED pitch of 0.5 mm, an aperture width of 1 mm and a distance between the LED layer and LCD layer of 40 mm, the angular resolution of viewing zones is about 0.5-1 degrees, e.g. there may be one viewing zone per each 0.5-1 degrees.

LEDs may be white, or they may be RGB color LEDs each comprising three LEDs, a red, a green and a blue LED in one housing.

An RGB LED may be selected so the red, green and blue LEDs inside the common housing may be located essentially on a common vertical axis.

Alternatively separate red, green and blue LEDs may be used, which may likewise be located on an essentially common vertical axis.

LEDs can be SMD components, COB components or prefabricated arrays of LEDs which may be assembled together on a PCB, which can also hold the controller 9 or part of the controller 9.

Alternatively, LEDs may be organic LEDs, for example thin film OLED.

LEDs may be selected or configured so they have a high peak pulse brightness, for example so they can make a flash of high intensity with a duration of less than 0.7, such as 0.5 or 0.3 or 0.1 milliseconds.

For example, LEDs may be of the brand Everlight model CSP0603AN101-WP30300563001-3T.

LEDs may be selected for essentially similar characteristics including opto-electronic transfer function, centre wavelength and forward voltage drop. This may result in better uniformity of observed images on the disclosed display.

The LEDs may be controlled/scanned with a passive matrix addressing circuit with horizontal electrodes, e.g. data lines, connected to cathodes of LEDs in a row.

Vertical electrodes, in this description also referred to as select lines, are connected to anodes of LEDs in a column.

Alternatively, data lines may be connected to anodes and select lines may be connected to cathodes.

The controller 9 may comprise current sources connected to data lines and switches connected at one end to corresponding select lines and at the other end to a common LED supply voltage. The current sources may be modulated by pulse amplitude modulation, e.g. the strength of a current may be controlled, or by pulse width modulation, e.g. a duration of a current may be controlled, or by combinations of pulse amplitude modulation and pulse width modulation.

Said in other words, the anode of all the LEDs in a column is connected to a switch, e.g. there is a switch for each LED column. Each switch is connected to a line called a “select line”—because a signal on that line switches on the switch and thereby “selects” a LED column.

Each LED has its cathode connected to a data line (row electrodes—extending horizontal).

A scan of the controller means that the controller sends a signal on the select line which switches on the switch so that the LEDs of a column emits light at a brightness corresponding (a function of) the data being provided to each LED by the data lines.

A scan of the display can also be said to constitute an update of the display (to a new set of images).

Not all led columns are necessarily selected in an update of the display.

A current through an LED during a pulse may be for example 0-40 mA. Hence, a column of LEDs may be flashed with a desired set of perceived brightness values for LEDs in said column by controlling the constant current sources with a combination of modulation settings corresponding to the desired set of perceived brightness values and then for the duration, no shorter than the flash activating a switch connected to a select line of said column of LEDs.

Hence, the LED array 2 may be controlled to flash LEDs in a column with a desired perceived flash pattern of brightnesses and/or colours with high intensity.

The disclosed display may be operated at a so-called frame rate (fps) for example 60 “frames” per second. For the disclosed display this frame rate defines the number of multiplexing cycles per second. Where in each multiplexing cycle a set of images is presented to corresponding desired viewing zones, one image for each of the observing eyes, e.g. if there are two observers watching 3D content there is generated four images per multiplexing cycle, e.g. the display generates 240 images per second. The two observers may be presented with the same right eye images and the same left eye images, e.g. a 3D display without look around effect.

As mentioned, the multiplexing cycle may comprise a scanning phase where the controller 9 directs the light modulator 1 to open one light valve column at a time while keeping the other light valve columns closed. The scanning may be performed from left to right or in any other sequence for example in a non-consecutive sequence.

A multiplexing cycle may further comprise a blanking interval Tb, during which the controller 9 directs the light modulator 1 to open all light valve columns while directing the LED array 2 to switch off all LEDs. This may extend the lifetime of the light modulator 1 by eliminating or reducing a time integrated DC build up over the liquid crystal cells.

The blanking interval Tb may be selected so the amount a liquid crystal cell is open during a duty cycle is essentially equal to the amount of time said liquid crystal cell is closed. For example, Tb may be calculated as Tb=(1/fps)×(Nc−2)/(2Nc−2) with for example fps=60 and Nc=32.

An interval during which a light valve column is open may then be calculated as ((1/fps)−Tb)/Nc.

In a configuration, the liquid crystal cells are essentially polarity insensitive the blanking interval may be omitted, e.g. Tb=0.

The controller 9 may receive eye position data from the face tracking system 8. For example, the controller 9 may receive eye position data periodically and store a copy of the last received eye position data in a memory. Additionally, the controller 9 may store or receive from an external source still images or moving images. It may store or receive a still or moving image for each eye in a set of observing eyes. For example, the controller 9 may store a first image intended for the first observing eye 4, a second image intended for the second observing eye 5, a third image intended for the third observing eye 6 and a fourth image intended for the fourth observing eye 7. Said first, second, third and fourth image may have a resolution of X pixel columns and Y pixel rows, where X may be equal to the number N of light valve columns and Y may be equal to a number of LEDs in a column in the LED array.

During each interval, in which a light valve column is open, the controller 9 may flash a set of LED columns with flash patterns one set at a time.

The LED column positions and flash patterns are calculated using eye position data, as described in further details below, thereby providing a directional display having a horizontal angular resolution and a set of vertically elongated viewing zones, where each may illuminate an observing eye.

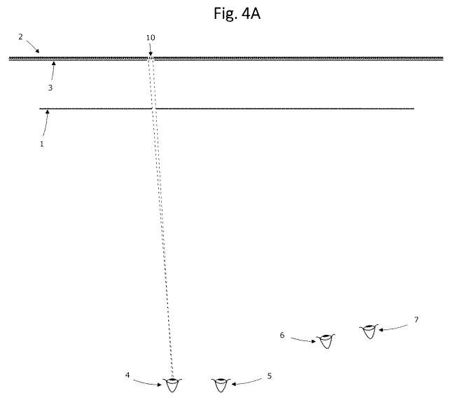

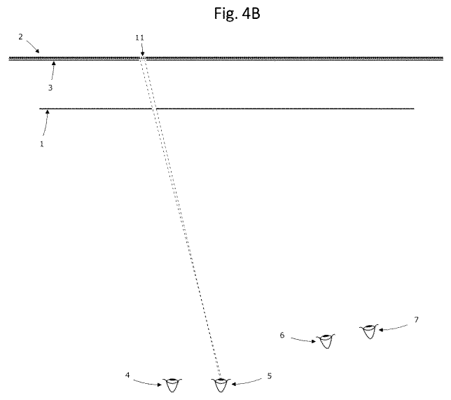

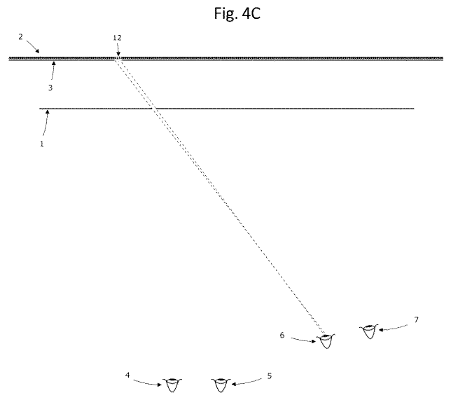

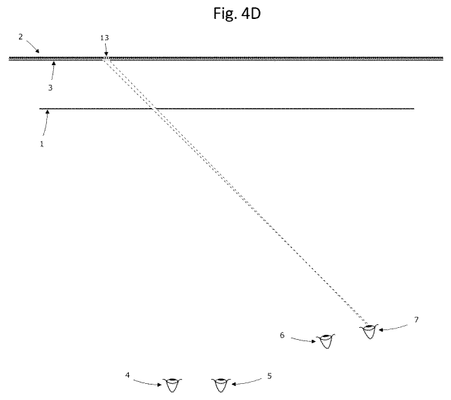

FIG. 4A is a top view of an example configuration of the disclosed display shown at a point in time of a multiplexing cycle where light valve column M is open, M being the column position counted from the left, and the other light valve columns in the spatial light modulator 1 are closed.

Light valve column M is open for a time interval T as mentioned above.

The example is a display without diffuser.

During the time interval, a set of LED columns (light spreader) 10 may be flashed with patterns essentially equal to a first LED column pattern (a column of the image to be displayed). In the present example three LED columns are illustrated as being flashed at the same time (in order to illuminate the whole aperture).

It is contemplated that an aperture is to be so narrow compared to the set of LED columns (light spreader) that light emitted from an edge of the light spreader is blocked, while light emitted closer to the centre of the light spreader is transmitted through the aperture (when the aperture is open).

Ray tracing may be used to determine how narrow an aperture is to be compared to the set of LED columns, e.g. enough LED columns have to flash light so that light from the edge will be blocked. This will ensure that the whole width of the aperture is illuminated.

Thus, the controller 9 may calculate the set of LED columns 10 using the received eye position data so the set of LED columns 10 illuminate a pattern which fills out horizontally the light valve column M as observed by the first eye.

For example, the controller 9 may calculate a centre and a width of an area on the LED array 2 corresponding to an area on the diffuser 3, which is observed by the first eye through light valve column M and then selecting the set of LED columns 10 to include LED columns, which are fully or partially covered by said area. In the example, three LED columns flash light.

The controller 9 may further calculate said first LED column pattern so it corresponds to pixel values in pixel column M in the first image. Hence, the first eye sees light valve column M filled out horizontally with a vertical pattern corresponding to pixel values in pixel column M of the first image.

Hence, when a full duty cycle/multiplexing cycle is completed in a similar way in for example 1/60^{th} of a second (when all apertures has been scanned—and the LED columns has been scanned as many times as there are eyes watching the display), the temporal integration of light in a human visual system will cause the first eye to see the first image displayed in full on the spatial light modulator 1, where the width of pixels is defined by the width of light valve columns and the height of pixels are defined by the height of LEDs plus any vertical smearing by the diffuser 3. The same will be the case for the second eye.

The display does not generate the images sequentially, e.g. one image after the other, instead part of each image to be displayed to the different eyes is generated when one aperture is open and so forth for each aperture. It could be said that when only considering one eye there is a pause between the generation of each column of the image—but the eye is not fast enough to see that. And in that pause a part of each of the other images is generated. When the scan of the apertures is complete, an image has been generated to all eyes.

FIG. 4B shows the configuration in FIG. 4A during the same interval as in FIG. 4A, where a second set of LED columns 11 may be flashed in a similar way to the above description, hence creating a vertical pattern in light valve column M as perceived by the second eye 5 corresponding to pixel column M of the second image.

Thus, so far an image column has been generated to the first eye and the second eye.

FIG. 4C shows the configuration in FIG. 4A during the same interval as FIGS. 4A and 4B, where a third set of LED columns 12 may be flashed in a similar way to the above description, hence creating a vertical pattern in light valve column M as perceived by the third eye 6 corresponding to pixel column M of the third image.

Thus, so far, an image column has been generated to the first eye, the second eye, and the third eye.

Finally, FIG. 4D shows the configuration in FIG. 4A during the same interval where a fourth set of LED columns 13 may be flashed in a similar way to the above description, hence creating a vertical pattern in light valve column M as perceived by the fourth eye 7 corresponding to pixel column M of the fourth image.

Now, an image column has been generated to all of the eyes and the next aperture may be scanned/opened.

When a specific aperture is selected/scanned such that it opens for light transmission, the controller then determines which LED columns are to be scanned such that it emits light—the specific LED column depends on the viewing zone once the aperture has been selected.

This happens one aperture at a time until the scan sequence has cycled through all of the apertures—completing the multiplexing cycle.

Thus, the liquid crystal cells are scanned with a frequency (number of occurrences of a repeating event per unit of time) of (Fc)=(Nc)/Tm (outside a blanking interval) while the LED columns are scanned at a higher frequency (Fc)×(Nz)—in the example four times higher.

Note that the sequence in which LED columns are flashed during the time interval T may not necessarily be in the order described above, e.g. FIG. 4 is an example.

The LED columns may be flashed in any order as long as they are flashed during the time interval T, e.g. the controller “jumps” between the LED columns—it is a non-consecutive sequence where a first LED column and a second LED column that is scanned during an open liquid crystal cell may be separated by a number of LED columns, e.g. there is a distance between the two—they are not neighbours.

LED columns in a set of LED columns may be flashed with essentially the same light patterns, such as for example the set of LED column patterns 10 could be flashed simultaneously by activating the corresponding three switches in the passive matrix addressing circuit simultaneously and setting the constant current drivers to three times the current. Another number than three columns may be contemplated, such 2 or 4 or 5 or 6 or 7 or 8 or 9 or 10.

In this configuration, LEDs may be selected for essentially similar values of forward voltage drop to ensure better uniformity of brightness patterns of LED columns in the first set of LED columns 10, since in this configuration with all three switches anodes will be connected to the common LED voltage supply, while cathodes are connected to a common data line, hence LEDs in the set of LED columns 10 will be essentially coupled in parallel.

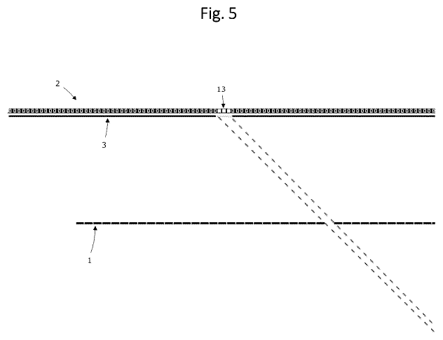

FIG. 5 is a close up of the set of led columns 13 and the diffuser 3.

The diffuser may be selected or configured so it essentially closes dark gaps between LEDs, e.g. it may spread light from illuminated neighbouring LED columns behind it so an essentially uniform vertical stripe is observed from the front. This may increase the horizontal uniformity of the vertical stripe hence ensuring that light observed through the light valve column has a centroid close to the centre of the light valve column, further ensuring a regular grid of observed pixel centroids which may result in better image quality.

The diffuser may be selected or configured to close gaps while not spreading light so much that there is too much spill over unto dark neighbouring LED columns, since this spill light might be observed by another eye not intended to observe it, creating crosstalk between for example the first image and the second image. Hence, a balance between closing gaps and light spill may be found for a desired compromise between a regular pixel grid and low crosstalk. Such a desired compromise may be found for example by trying a number of diffusers with different degrees of diffusion and selecting the preferred compromise. For example, the diffuser may have a point spread function with a full width-half maximum fall-off radius of for example equal to a centre distance between LEDS. To improve this compromise a diffuser with a batwing light distribution may be selected. Alternatively or additionally, a pattern of varying neutral densities (not shown) configured so it eliminates or reduces brightness variations on the diffuser 3 may be comprised. The pattern may essentially be a reverse (e.g. negative) reproduction of the brightness variations on the diffuser 3 as observed from the front, e.g. from the side facing towards to spatial light modulator 1. The pattern may for example be printed on the diffuser 3. If the diffuser 3 has a structured and a flat side, that pattern may be printed on the flat side. Alternatively, the pattern may be printed on a transparent sheet which may be laminated onto the diffuser 3.

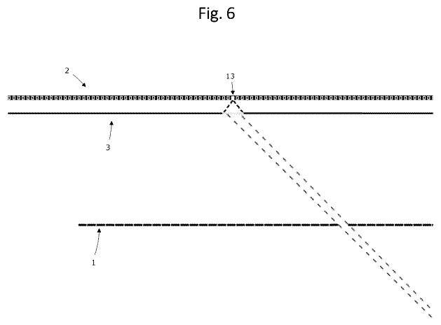

FIG. 6 shows an alternative configuration, where the diffuser 3 is located with a large distance the LED array 2.

The distance may be large enough so that a spot created from an LED is large enough to fill out a light valve column as observed from an observing eye located within a desired observation distance range with light not varying more over the width of the light valve column than a maximum allowed brightness variation, for example 20%. The distance between the diffuser 3 and the LED array 2 may be calculated with well-known geometry using a radiation angle of an LED, a diffuser full width-half maximum, a width of a light valve column and a minimum and maximum viewing distance. For example, LEDs may have a radiation angle of 45 degrees full width-half maximum and the distance between the diffuser 3 and the LED array may be 1.5 times a width of a light valve column. An advantage of this configuration is that during the interval, only one LED column per eye needs to be flashed, which may reduce requirements to the speed of driving circuits for LEDs.

Some measures may be taken to improve light efficiency. For example, a first lens array of vertical cylinder lenses having a pitch essentially equal to the pitch of the LED array may be comprised located in front of or behind the spatial light modulator 1 with cylinder lenses positioned having vertical centre lines essentially coinciding with vertical centre lines of light valve columns. A lens in the first lens array may be configured with a focal length equal to a distance to an LED directly behind said lens. Additionally or alternatively, a second lens array of cylinder lenses may be comprised in front of the LED array 2 with a lens centre positioned essentially over LED centres. A lens in the second lens array may be configured so it radiates light in a range of angles corresponding to a range of desired viewing angles for the disclosed display.

The processor 9 may calculate a set of don't-care light valve columns.

The set of don't-care light valve columns may be calculated using a set of positions of LEDs which are flashed during when a liquid crystal cell is open and a set of positions of observing eyes, so that essentially none of the observing eyes will observe light from LEDs flashed if any of the light valve columns in the set of don't-care light valve columns are opened by the controller 9.

The processor 9 may open the set of don't-care light valve columns or a subset hereof and it may shorten the duration of the blanking interval with an amount of time essentially equal to the number of opened light valve columns in the don't care set times the duration. An advantage of this configuration is that it may increase frame rate and brightness of the disclosed display. The controller may calculate the don't care set, so a DC offset balance over the liquid crystal cells over an interval Tlc is kept essentially at zero volt. Tlc may for example be one second.

FIG. 7 shows an arrangement of a modular display, where several displays/modules according to the disclosed invention, below referred to as display modules, may be “assembled” to form a larger display.

It is contemplated that each (liquid crystal) module may comprise a set of at least eight liquid crystal cells (spatial light modulators) or comprise a number of liquid crystal cells in the range 8-80 liquid crystal cells, such as 20-40 liquid crystal cells. In practice it is contemplated that a set has 30 or 32 liquid crystal cells.

Display modules may have essentially equal light valve column pitch, e.g. a light valve column pitch of a first display may be equal to a light valve column pitch of a second display module, where pitch meaning a centre-to-centre distance of light valve columns.

Display modules may be assembled so a first light valve column located as the rightmost light valve column in a first display module is located adjacent to a second valve column located, as the leftmost light valve column in a second light display module with a distance from a centre of the first light valve column to a centre of the second light being essentially equal to a pitch of a light valve column pitch of the first and second display module. In other words, spatial light modulators in the display modules may be arranged so essentially all light valve columns in the larger display have equal pitch.

Spatial light modulators in the display modules may be located on a glass substrate holding light modulators for several display modules, for example there may be a single glass substrate for the larger display holding light modulators for all display modules. In this arrangement, LED arrays may have the same width and height as spatial light modulators, hence LED arrays can also be assembled adjacently, so LEDs in the larger display have equal pitch horizontally and vertically. In other words, LEDs of assembled display modules may form one large LED array.

LED arrays may be mounted on a single PCB for the larger display or on separate PCBs, for example one PCB for each display module, physically assembled precisely enough together for LEDs to form one larger array. Technologies for such precise assembling are well known in the art of LED video walls, LED digital signage and micro LED displays. Display modules may share LEDs, e.g. an LED in a first display module may be flashed to illuminate an observing eye through a light valve column in a second display module.

In an especially advantageous configuration, LEDs in the above description may be replaced by directional light emitters, having a vertical angular resolution, e.g. capable of emitting light in a number of horizontally elongated viewing zones at different vertical angles. Such directional light emitters may be configured according to well-known art of directional pixels, for example each directional light emitter may comprise a set of LEDs located behind a focusing such element, such as a lens.

For example, the directional light emitters may be capable of emitting light in two different directions, a lower viewing zone and an upper viewing zone. In this case, each light emitter may comprise two LEDs and these two LEDs may be comprised in a passive matrix driving circuit.

An advantage of this configuration is that it has both a horizontal and a vertical angular resolution, and for example, if the display is located in a living room, a first image may be sent to a first observing eye belonging to a person sitting on the floor and a second image may be sent to a second observing eye belonging to a person sitting in a sofa, where said first and second image may be different, even if said first and said second observing eye are located on a same vertical.

The modules are controlled (by one or more controllers) such that they operate in parallel.

In the example, the display comprises five “modules/segments”. This can be seen, because it is illustrated that five columns of light are emitted to each viewing zone.

Each module operates as described in connection with FIG. 4, but the image is also divided into “parts”, e.g. a first module is responsible for generating a first part of the image, and a second module is responsible for generating a second part of the image etc.

Each module has one liquid crystal cell open at a time—with five modules this means that five columns of the image are generated at a time and directed to the observer.

Similarly, each module has one light emitter column (it may be a plurality of adjacent light emitter columns to ensure an aperture is filled with light) that is scanned and flashes light, e.g. in the example five light emitter columns are scanned to emit/flash light.

The modules may be scanned independently from each other, e.g. one module may have a scan sequence that scans the liquid crystal cells one after the other from left to right, and another module may have a scan sequence where the crystal cells are scanned at random one after the other.

The modules may be controlled by the controller of the display such that at a point in time during a multiplexing cycle at least 80%, such as 90%, of the modules have a liquid crystal cell in the light transmitting state, e.g. the modules are controlled in parallel.

A first module may be scanned as a function of the scanning of a second module and the position of an observer/viewing zone, e.g. a set of liquid crystal cells may have a scanning sequence depending on the scanning sequence for a set of liquid crystal cells for another module. Similarly, a set of LED columns may have a scanning sequence depending on the scanning sequence for a set of LED columns for another module.

The number of LED columns is preferably to be higher than the number of liquid crystal cells in a module, e.g. the width of the area occupied by the LED columns is greater than the width of the area occupied by the liquid crystal cells. Thus, there is an overlap between the LED columns that are used by two sets of liquid crystal cells. Thus, an aperture in a first set of liquid crystal cells may be illuminated by a certain LED column, and that LED column may also flash light for illuminating another aperture (in another module), e.g. two sets of liquid crystal cells share a number of LED columns. It also means that the total width of all LED columns is greater than the total width of all the liquid crystal cells—the disclosed display can be recognized by a bezel (one way to visually distinguish between the disclosed display and a lenticular display or a parallax barrier display.

The example illustrates two viewing zones (right eye=red rays, and left eye=green rays). Thus, during the time interval T (in which a liquid crystal cell in each of the modules has been selected to be open) the light emitters (in each module) that are in a position such that light will reach the right eye are scanned, such that they flash light and afterwards (within the same time interval T), the light emitters (for each module) that are in a position such that light will reach the left eye, are scanned such that they flash light.

However, in the case of the display having an active matrix addressing scheme (with a memory component, such as a sample and hold circuit for each light emitter column) a light emitter column for each viewing zone is scanned/addressed for turning it on such that a plurality of light emitter columns end up emitting light at the same time. When the last light emitter column has been turned on, they are all turned off collectively, e.g. at the same time before proceeding to the next liquid crystal cell in the scanning sequence.

It may be that a viewing zone is at a sharp angle, e.g. an observer is positioned to the side of the display. This means that during a multiplexing cycle, two neighboring modules (first and second module) may be controlled such that it is necessary that a liquid crystal cell of the second module is in a light transmitting state for transmitting light from a LED column of the first module.

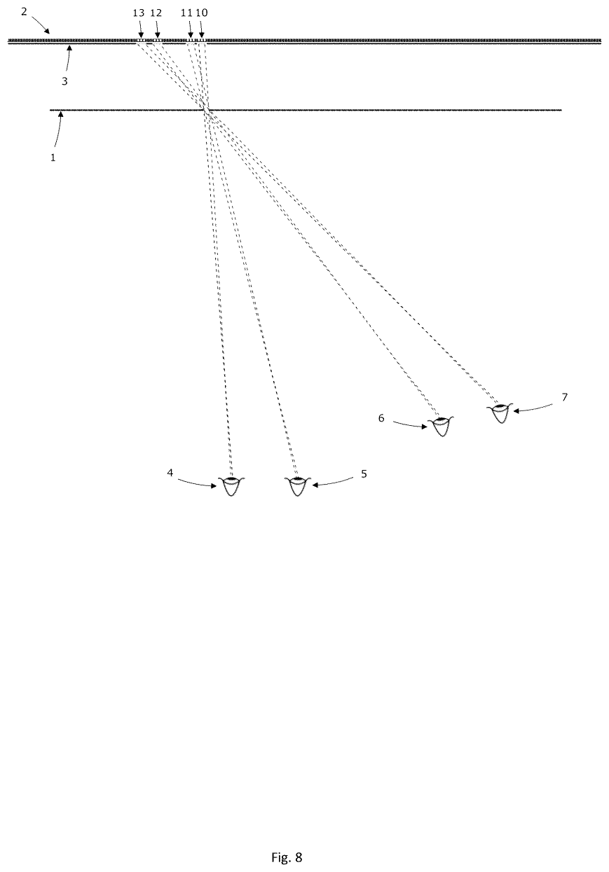

FIG. 8 shows an example of an active matrix addressing scheme.

Compared to the passive matrix addressing scheme described above in connection with 4, all sets of LED columns for the number of viewing zones (in this example four viewing zones) are emitting light substantially at the same time, e.g. there is a time interval (for example 1/N of a multiplexing cycle, where N is the number of liquid crystal cells in a module) in which all four sets of LED columns emit light—the time interval where a liquid crystal cell is open.

Substantially means that one LED column may be about to turn off while the other is about to turn on.

The LED columns to be on when a liquid crystal cell is open is scanned in sequence, e.g. one after the other while data is provided in data lines to each LED and read into the memory component of the driver circuit (sample-and-hold register for example) for each LED. Thus, the LED columns turn on one after the other and when the time interval has passed all of them are closed substantially at the same time.

In the example the set of LED columns comprise three LED columns for each viewing zone (in order to fill out the aperture with light). Thus, there are 4×3 LED columns that are on. When they are “turned off” the off-signal is provided on the 12 select lines connected to these LED columns while the data-lines are set to zero.

A disadvantage of an active matrix addressing scheme is that in practical implementations, an active matrix display is usually manufactured in thin film and this sets limits to how bright the display can be.

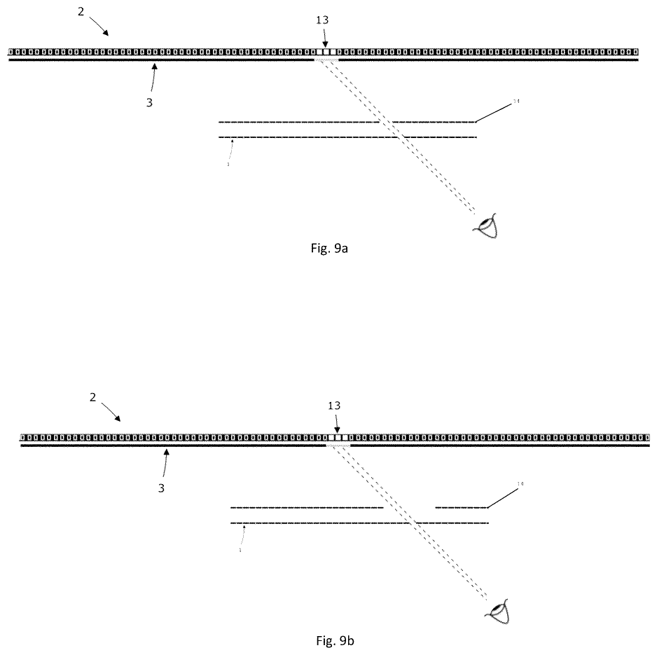

FIGS. 9a and 9b show the disclosed display with two liquid crystal layers, e.g. there is an additional layer of liquid crystal cells.

The additional layer 14 is arranged between the light emitters and the layer with the scanning apertures, e.g. the layer described in connection with FIG. 4 for example.

The purpose of the additional layer is to avoid crosstalk, e.g. the liquid crystals cells of the aperture layer may transmit some light even when they are in the blocking state, which creates crosstalk.

The purpose of the liquid crystal cells in the additional or second layer is not to focus and delimit the light from the light emitters as in the “first” aperture layer.

The liquid crystal cells in the additional layer are also scanned in a sequence during the multiplexing cycle. The sequence or selection of each liquid crystal is a function of the liquid crystal cell that is open in the first aperture layer, and the viewing region/zone/angle with respect to the display that the generated image is visible at.

A set of liquid crystal cells is selected in each step of the multiplexing cycle—there may be more than one liquid crystal cell selected.

FIG. 9b is a more simple implementation, where the number of liquid crystal cells that are open in the additional layer is a function of the viewing angle of the display and not the specific viewing zone as in FIG. 9a.

The viewing angle of a display is the maximum angle at which the display can be observed with acceptable visual performance.

This means that a higher number of liquid crystal cells in the additional layer are open compared to the implementation described in connection with FIG. 9a. The disadvantage is that crosstalk may not me reduced to the same degree as for FIG. 9a.

An even more simple configuration may be to make each liquid crystal cell in the additional layer wider compared to the width of a liquid crystal cell in the aperture layer. Such a wider configuration can also be achieved by controlling neighbouring liquid crystal cells, such that for example two or three or four neighbouring liquid crystal cells are open substantially at the same time.

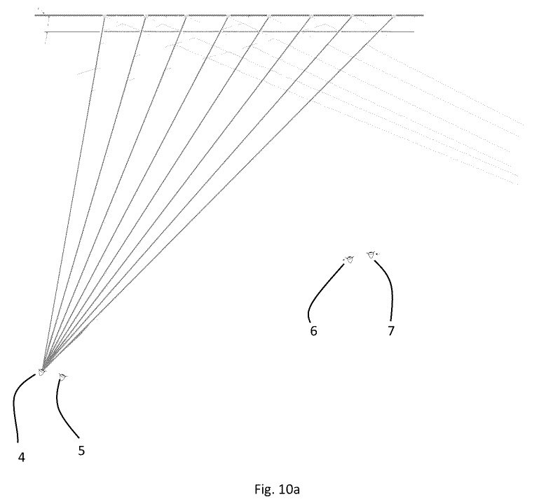

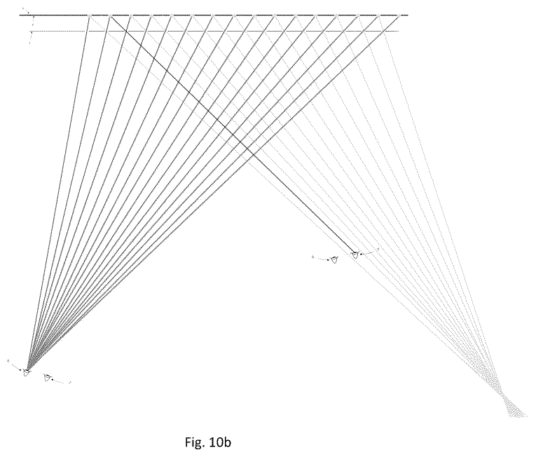

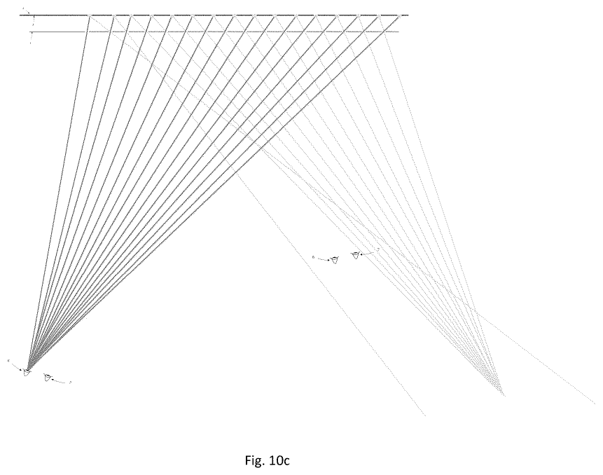

FIG. 10a-c shows how view crash may be avoided.

The modules of the disclosed display introduce a risk of view crash (part of an image intended for a first viewing zone is visible in another viewing zone).

The number of liquid crystal cells in a module may be a function of the brightness of the light emitters, e.g. choosing light emitters with high brightness can reduce the risk of view crash, because there can be a higher number of liquid crystal cells in a module.

There is a trade-off between loss of brightness and risk of view crash—the higher the number of liquid crystal cells in a module the lower brightness, and the lower the liquid crystal cells the higher the risk of view crash. The number of liquid crystal cells in a module is a balance between the risk of view crash and loss of brightness.

FIG. 10a shows a display with 8 modules.

Four eyes are observing the display.

The modules are scanned in parallel such that each module has one open liquid crystal cell thereby creating a number of light pattern (8 in the example) that are emitted from the display.

As can be seen, light from an LED in one module can escape through an open liquid crystal cell in another module, e.g. there is a module “responsible” for the view crash, because it has a liquid crystal cell open, and there is a “original” module from where the light pattern has been emitted.

FIG. 10b shows a display with 16 modules.

In this example, one of the eyes receives an unintended light pattern and there is a view crash.

Such a view crash may be determined by a tracker and the controller, e.g. the tracker informs the controller of the position of the observing eyes (active viewing zones). The tracker may also track the number of observers—or at least up to a certain number of observers. For example, the display may be configured to display 3D content to a number of observers, and when that number of observers exceeds a threshold, such as 4 or 5 or 6 or 7 or 8 or 9 or 10 observers, the display switches from displaying 3D to displaying 2D to either all observers or only to the observers above the threshold, e.g. a first number of observers still observers 3D content, but the remaining observers observe 2D content.

The display is to direct the images to the intended viewing zones so starting with a first eye, the multiplexing cycle may be defined for example by scanning one liquid crystal cell after the other one by one in a consecutive sequence and scanning the needed LED columns one by one starting with the LED column for a first active viewing zone.

Thus, the controller knows which liquid crystal cells are open in each module and which LED columns are selected in each module. The controller can therefore determine if there will be a view crash before it happens.

In FIG. 10c is illustrated that the view crash has been avoided.

A solution for avoiding a view crash may be to change the scan sequence of the liquid crystal cells of the module responsible for the view crash.

A specific solution could be that if originally a scan of liquid crystal cells from right to left in the responsible module leads to the view crash, the scan sequence could be changed so that the liquid crystal cells in the responsible module are scanned from left to right. It could also be the other way around, e.g. that the scan sequence of the liquid crystal cells in the “original” module is changed.

Any change in scan sequence of liquid crystal cells of a module is adequate, as long as the view crash is avoided, it could also be that two elements (liquid crystal cells) in the scan sequence are interchanged in one of the modules.

In general, to avoid view crash, the scan sequence of the liquid crystal cells of the responsible module is changed depending on the scan sequence of the liquid crystal cells of the original module or vice versa.

FIGS. 11a-c also show a modular display as shown in FIG. 7 and with two layers of liquid crystal cells as shown in FIG. 9.

The display has two modules and there are four active viewing zones (two observers observing 3D content).

Light patterns are illustrated as being emitted at the same time, e.g. as in an active matrix display (also shown in FIG. 8) where columns are selected one by one and emit light until they are de-selected simultaneously.

However, the figure should not be understood as being limited to active matrix displays, but rather show how light is emitted also for a passive matrix display—where one column at a time in each module flashes light.

The figures (FIG. 11a-c) show a sequence (on the same page) of how each aperture in the two modules “moves” and has three different positions (a different position in each figure) and how different columns are selected and emit light.

The above figures have illustrated how a module may be operated and how a plurality of modules operates in parallel (or substantially in parallel), and how the aperture layer and light emitter layer works as a stand-alone display.

In the following it will be disclosed how this stand-alone solution can be used as backlight for a LCD panel and in that way achieve a 3D or multiview display.

In that solution, the aperture may still define the pixel width, but the pixel height is then determined by the LCD panel and not the light emitter layer. The hybrid scan display still emits images—the only difference is that it is purely white uniform images that are generated—which the LCD panel then modulates.

It has also been described above that when the aperture is at a position a number of (light emitter) columns flash light depending on the number of viewing zones, e.g. for each aperture position is jumped back and forth between columns emitting light for directing light towards the active viewing zones. This is based on the assumption that the light emitters may be switched/updated faster than the liquid crystals. However, for a display having a maximum number of active viewing zones (such as no more than 6 active viewing zones for supporting a “3D look around” experience for three observers for example) it may be that it is the aperture that “jumps” around, e.g. the image parts for the images to be displayed to the active viewing zones are still interleaved but instead the same column flashes light a number of times corresponding to the number of active viewing zones—a different light pattern is emitted with each flash (if it is to be look around—if it is only to be 3D, the same light pattern is flashed to all the right eyes and the same light pattern is flashed to all the left eyes) and for each flash there is an aperture position such that the flash is visible in the desired active viewing zone.

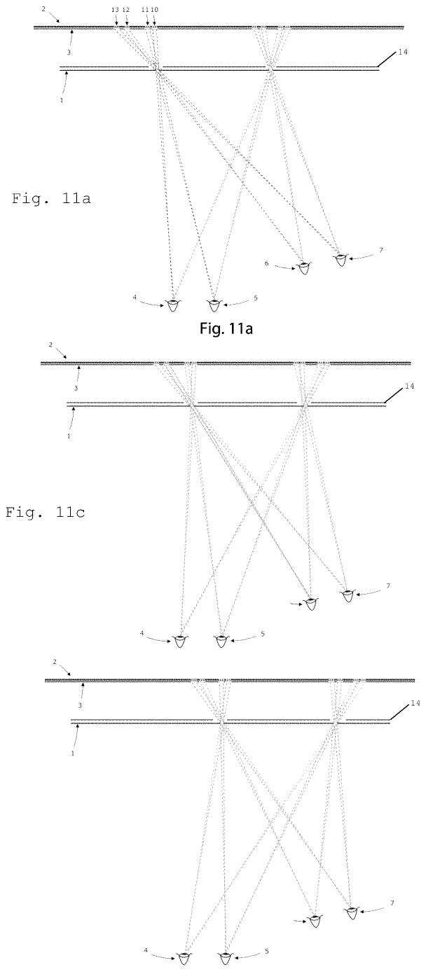

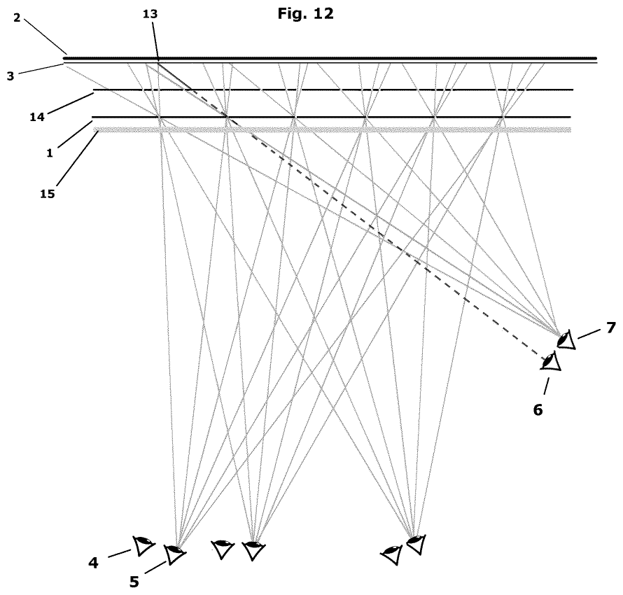

FIG. 12 shows a top view of a configuration where the Hybrid Scan Display is used as a directional backlight, specifically for a time division multiplexed LCD panel 15.

This may achieve a multiviewer or autostereoscopic display having a higher resolution and/or larger color gamut than compared to when the Hybrid Scan Display operates as a stand-alone display.

A standard commercially available LCD display may be used and have its backlight removed and replaced with the hybrid scan display as backlight for the LCD panel 15.

The LCD panel 15 may be operated so it alternates between a left eye time slot, in which it shows a left eye perspective image and a right eye time slot, in which it shows right eye perspective image.

FIG. 12 shows the configuration in a right eye time slot.

The Hybrid Scan Display may be synchronized to the LCD panel, so it illuminates a set of left eyes in an audience when said left eye perspective image is being shown and so it illuminates a set of right eyes in an audience when said right eye perspective image is being shown.

For example, the Hybrid Scan Display may show a uniform white image or a backlight dimming zone image for a left eye image when the LCD panel shows a left eye perspective image, and the Hybrid Scan Display may show a uniform white image or a backlight dimming zone image for a right eye image when the LCD panel shows a right eye perspective image. Hence, left eyes in the audience will see the left eye perspective image and right eyes in the audience will see the right eye perspective image, and members in the audience will see the same stereoscopic image.

The LCD panel 15 may be operated in a frame tripled, strobed mode, so that each image being scanned out three times by the panel, but only the third time the backlight is active, giving time for the liquid crystal cells to respond to update values before the backlight is active.

The LCD panel 15 may for example be operated at 360 Hz and have a pixel response time from 0% to 80% gray being less than 2.5 ms and a pixel response time from 80% to 0% gray being less than 2.5 ms. The LCD panel may for example be a ZOWIE XL2566K monitor from BenQ eliminated its original backlight.

An input sequence to the Panel 15 may for example be: L1, L1, L1, R1, R1, R1, L2, L2, L2, R2, R2, R2, where L1 and L2 are left eye perspective images and R1 and R2 are right eye perspective images. After completion of the first scan-out of the L1 image, all liquid crystal pixel cells will substantially be updated with a voltage across their electrodes corresponding to pixel values in L1. After completion of the second scan-out of L1, all liquid crystal pixel cells will substantially have reached their target values, since the scan-out will have a duration of equal to or less than 1/360 Hz=2.8 ms, which is longer than the response times of 2.5 ms. Hence, when the third scan-out of L1 begins, all pixel cells have substantially reached their target values and they will remain at these during the third scan-out, and the backlight may then be active during the third scan-out. The same procedure may be applied for updating images R1, L2, R2 etc. Hence, there will be substantially no crosstalk between left and right eye perspective images due to pixel response times.

Alternatively, the backlight may be divided into a number of sections which are active in different intervals, synchronized with intervals in which liquid crystal pixel cells of the LCD panel have reached their target values. For example, the backlight may be divided into a first section located behind a first half part of the screen, which is being updated first during a scan-out, and a second section located behind a second half part of the screen, which is being updated after the first half part. The first section may be active during the second half of the scan-out of the second L1 and during the third scan-out of the third L1. The second section may be active during the third scan-out of L1 and during the first half of the scan-out of R1. In this configuration, the interval during which the first section and the second section are active may be 50%. The first and second sections may be Hybrid Scan Displays arranged horizontally and the scan-out direction of the Panel 15 may be horizontal. A blanking interval Tb of a Hybrid Scan Display in this configuration may be synchronized with the intervals described above in which the Hybrid Scan Display is not active.

In general, the hybrid scan display and LCD panel are synchronized such that when a column of liquid crystal of the LCD panel have been scanned/updated such that the crystals in that column are at their target values/intended values, or at least close to that, such as 80% updated, the moving aperture is controlled/scanned, such that it is behind an updated column and the light emitters of the backlight are selected such that light travels to active viewing zones. For example, for a right eye image, all right eyes receive light first whereafter a left eye image is generated in the LCD panel and all left eyes receive light. Specifically, an area forming a vertical band on the LCD panel 15 to the right of an active scan line may be illuminated, so pixels/crystals of the LCD panel are illuminated just before they are updated to a new value.

It may be arranged such that the moving aperture follows the movement/scanning of the LCD panel, e.g. the LCD panel may be scanned from left to right, and so the aperture may move left to right such that has it moves along it is behind an updated column in the LCD panel. In general, it does not have to be left to right it could be any movement as long as the whole image will be displayed.

The illustrated LED array 2 in the example may comprise white LEDs, since the Hybrid Scan Display in this configuration only functions as a directional white backlight for the LCD panel 15, which may comprise a color mask.

The illustrated diffuser 3 in the example may be selected or configured so it performs enough diffusion of light in both the horizontal and vertical direction to essentially eliminate visual dark gaps between LEDs, hence eliminating or reducing moireee patterns caused by interference between such dark gaps and a black matrix and/or color mask in the LCD panel 15.

Further, the light modulator 1/liquid crystal cells and the additional light modulator 14 may be configured, so they have no or little periodic opaque mechanical structures, such as black matrix, periodic spacer structure or other mask, hence eliminating or reducing moireee patterns caused by interference between such opaque structures and a color mask and/or black matrix in the LCD panel 15. Gaps between light valve column electrodes in the light modulator 1 and in the additional light modulator 14 may be minimized in order to reduce light leakage in the absence of a black matrix.

With gaps between electrodes minimized, the width of a scanned area on the light modulator 1, e.g. an area scanned during a multiplexing cycle, is determined substantially by the number of light valve columns scanned multiplied by the width of a light valve column, and the number of LED columns is determined by the width of a scanned area, the distance between the light modulator 1 and the LED array 2 and a desired angular resolution of the display. For example, the number of light valve columns scanned may be 32 and the width of a light valve column may be 1 mm as in the above example, the distance between light valve columns substantially zero and the horizontal pitch of the LED array 0.5 mm.

The horizontal resolution of the backlight (Hybrid Scan Display) is thus determined by the pitch of the LED array and the display size and can be smaller than the horizontal resolution of the LCD panel 15, thus making manufacturing of the LED array 2 easier.

The resolution in the vertical direction of the LED array 2 can be much smaller than the vertical resolution of the LCD panel 15. For example, all LEDs in one column may be controlled so they always have essentially the same brightness value, hence the LED array has an effective vertical resolution of one pixel (having a very high rectangular shape, stretching from top to bottom). This is different from the stand-alone hybrid scan display where a column in the LED layer comprises a plurality of light emitters in order to generate a column of the image, e.g. generate the vertical pixels of an column of the image to be displayed.

Alternatively, neighboring vertically aligned LEDs may be grouped into vertical groups of LEDs forming vertically elongated “pixels” controlled so they operate essentially identically. Such vertically elongated pixels may be used to form dimming zones for enhancing the contrast of the LCD panel 15; dimming zones and algorithms for calculating brightness of these being well known in the art of LCD displays.

In a right eye time slot, only right eyes of an audience should be illuminated, no left eyes should be illuminated from any part of the display, and vice versa, since crosstalk would then be experienced.

The additional light modulator/aperture layer 14 may be configured to select liquid crystal cells for opening, which are not in the path of undesired light rays. Hence, the additional light modulator 14 may be configured to assist in eliminating undesired illumination of eyes by shielding light rays in undesired directions, e.g. light rays towards a viewing region/angle which the generated image should not be visible at. This has also been explained above in connection with FIG. 9, which shows an example of the hybrid scan display comprising an additional layer of crystal cells.

Consider for example FIG. 12 where an LED column 13 is being flashed to illuminate a right eye 5 of a first observer, with a first light ray here shown as a gray line. Without the additional light modulator 14 configured as described, LED column 13 would also send a second light ray, shown here as a red, dotted line, towards a left eye 6 of another observer, causing crosstalk to be experienced. With the additional light modulator 14 configured to select liquid crystal cells for opening, which are not in the path of undesired light rays, the additional light modulator 14 would have a closed liquid crystal cell in the path of the second light ray, substantially blocking it and eliminating or reducing cross-talk at left eye 6.

The additional aperture layer as well as the diffuser are as such not necessary but may be used to achieve greater image quality.

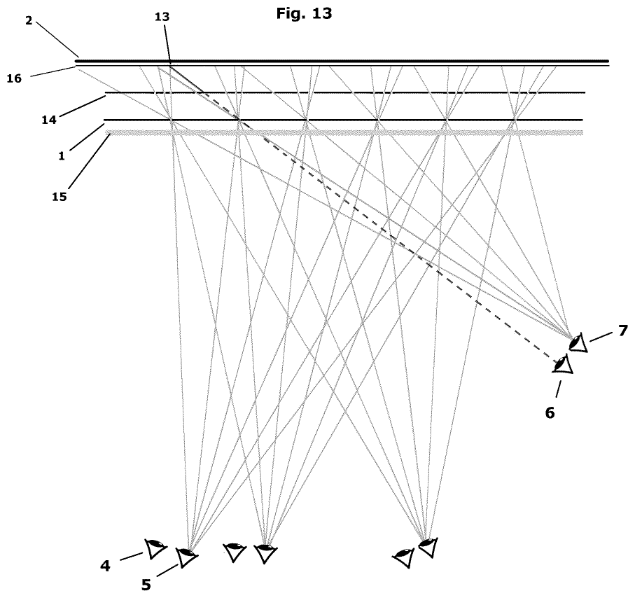

FIG. 13 shows an example configuration with a light guide plate 16, which constitutes an example of a horizontally delimited light emitter, e.g. an elongated light emitter—having a height much greater than its width (during intended operational use), such as more than 2 times greater or more than 3 times or 4 times greater. Another example would be an elongated OLED. Thus, light is emitted as a column of light—the column preferable extends from top to bottom of the display.

Thus, a vertically elongated light emitter may be an assembly of a LED and a light guide that distributes the light from the LED vertically such that light is seen as a vertical strip of light. Alternatively, it could be an elongated LED as mentioned above.

This may enable using fewer LEDs and less complex electronics, because only one LED may be needed to illuminate the light guide, e.g. the light guide guides the light from the LED vertically so that a stripe of light is emitted—otherwise, a plurality of LEDs in a column would have to be needed (this would be the case when the hybrid scan display functions as a stand-alone display).

Further, a light guide may increase the precision of the light sources emitting light towards the LCD panel 15, for example it may be molded with a higher precision than LED mounting tolerance on the PCB, and it may be able to capture light from LEDs mounted with varying precision into the more precisely located light guides.

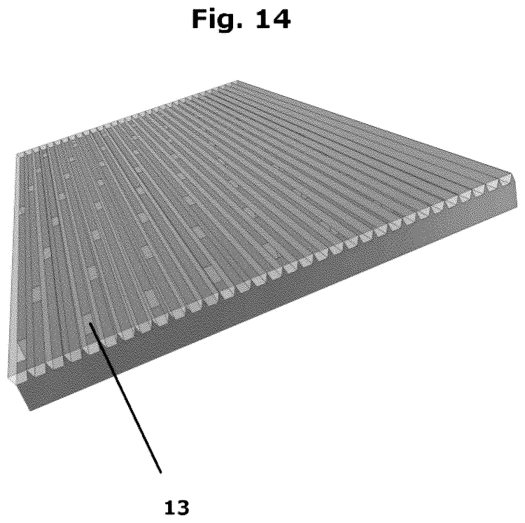

FIG. 14 shows a perspective view of an example of a light guide plate and a spacer located between the light guide plate and a printed circuit board holding the LEDs in the LED matrix 2.

The light guide plate couples light in from LEDs (first LED 13) on the printed circuit board and outcouples it substantially as uniform thin vertical stripes of illuminated surface.

There may be incoupling features in the side facing the LEDs and outcoupling features in the side facing the LCD panel 15, such features being calculated and optimized using for example Zemax OpticStudio from company Ansys. The spacer may have light baffles separating leaking light between light guides.

At the top and/or at the bottom may be located mirrors, oriented orthogonal to the light guide, to reflect light from the light guide so it is emitted at non horizontal angles, in other words extends the appearance of the light guide at the top and at the bottom. This can save a top and/or bottom bezel.

At side bezels, loudspeakers may be included to hide the bezels or in other words make good use of this space.

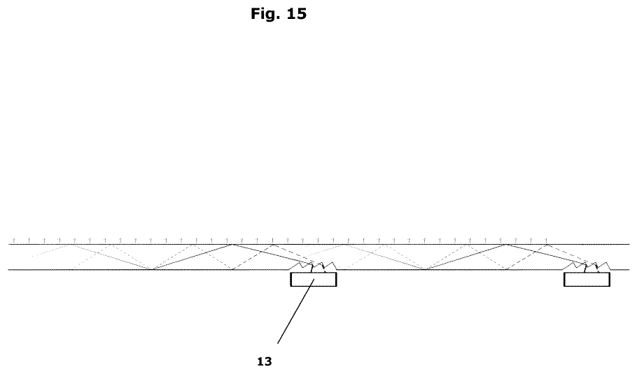

FIG. 15 shows an example of a configuration of a light guide.

The light guide is illustrated as being elongated, e.g. having a height greater than width as mentioned above.

The example has two LEDs that emit light into the light guide and the light experience reflections. The light travel is illustrated as the ray traced lines inside the light guide.

FIG. 16 shows a top view of an example a printed circuit board module holding the LEDs in the LED array 2.

LEDs may be arranged in a staggered pattern, providing more distance between LEDs for wire routing etc.

In the example there are three LEDs per vertical line, e.g. more than one LED per vertical line. In a neighboring line the LEDs is at another vertical position thereby achieving the staggered pattern.

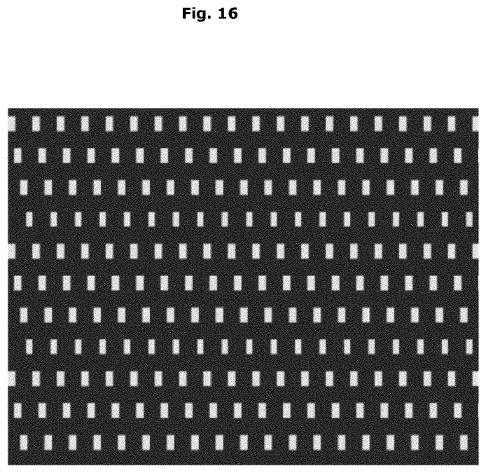

FIG. 17 shows a top view of an arrangement of a set of printed circuit board modules, e.g. for a modular construction of the display.

Each PCB module comprising a PCB with LEDs. The staggered LED pattern allows for a more seamless connection between PCB modules, e.g. any bezel between PCB modules may be avoided or at least reduced compared to a non-staggered pattern. It will therefore be less obvious to notice by an observer that the display has been assembled with (physical) modules.

Printed circuit boards may be held in place by for example being glued onto the light guide plate. The light guide plate may cover the full display, thereby ensuring precision of light emitters. Thus, in such an example the light guide plate has a greater area than a single PCB.

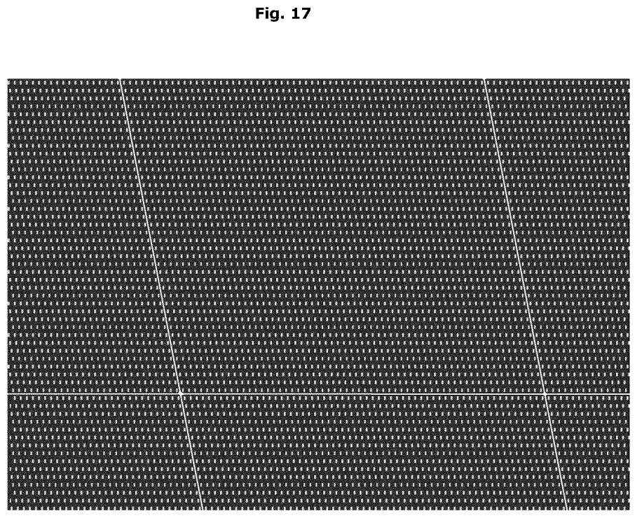

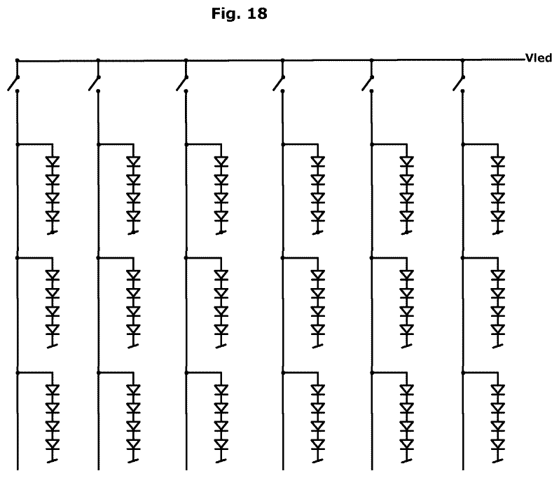

FIG. 18 shows an example schematic of an electrical circuit for controlling the LEDs in the LED array 2.

LEDs may be grouped into groups of 4 neighboring vertically aligned LEDs and they may be controlled so LEDs in each group operate essentially identical, for example by electrically connecting the 4 LEDs in a group as a series-connected string and connecting the string to a voltage source controlled by the controller 9 (not shown in FIG. 18). Connecting LEDs in strings may mitigate the disadvantage of using a voltage source rather than a current source, because variations in characteristics of LEDs are averaged resulting in a more consistent illumination of LEDs vs voltage than if LEDs were coupled directly in series. The advantage of using a voltage source is that several columns of LEDs may by illuminated simultaneously by simply connecting strings in more than one row to a supply voltage, for example by closing more than one switch in the shown schematic.

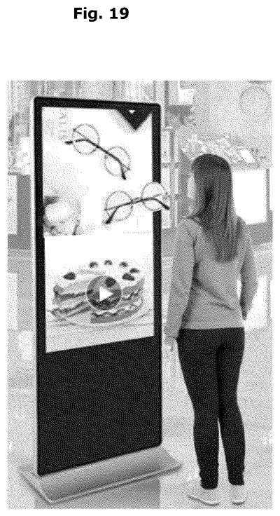

FIG. 19 shows a perspective view of an example configuration, where the Hybrid Scan Display is used as a backlight for a large LCD panel 15 in poster/portrait mode (as opposed to the normal landscape orientation that displays normally have, e.g. more pixels horizontally than vertically) built into a display stand and used for digital signage and advertising. The LCD panel 15 may be a 65 inch panel having an active area with dimensions of approximately width×height=81×144 cm, for example it may be a model QN90B 65 from company Samsung.

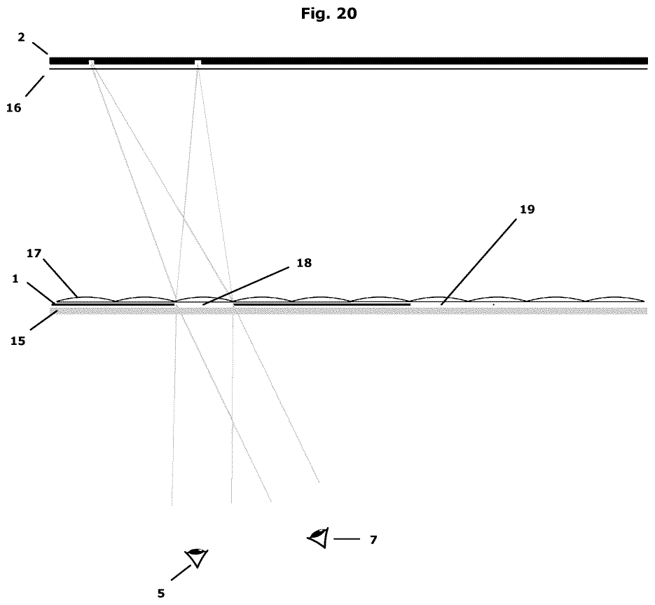

FIG. 20 shows a top view of the example configuration from FIG. 19, where the Hybrid Scan Display is used as a backlight for the LCD panel 15.

However, the example may also be applied to a landscape mode orientation of the display.

A lens array 17 comprising cylindrical (or acylindrical) lenses may be located adjacent to the panel 15 for example on the side towards the LED array 2. The lens array 17 may have a plane side and this may be oriented towards the panel 15. The configuration may be optimized for the lens array 17 to be close to the panel 15. Light from the LED array 2 transmitted through the lens array 17 may be unpolarized hence avoiding any unwanted effects from birefringence in the lens array 17.

The lenses and the light valve columns/liquid crystals of the hybrid scan display may in this configuration be much wider than in above configurations. For example, light valve columns and cylinder lenses may be 25 mm wide. The LED array 2 may be located for example 100 mm behind the panel 15 and lenses may have a focal length of 100 mm, hence they may transmit light received from a small area on the LED array 2 as essentially collimated light at the side facing observing eyes.

The panel 15 may be operated at a frame rate of for example 120 fps alternating between left and right eye perspective images, and it may be oriented so it has pixel update scans going from left to right. The Hybrid Scan Display may scan from left to right, synchronized with the update scans of the panel 15, so pixels in the panel 15 are illuminated when they have had time to respond to an update. For example, an area forming a vertical band on the LCD panel 15 to the right of an active scan line may be illuminated, so pixels are illuminated just before they are updated to a new value.

The illuminated vertical band may be substantially equal to an area of a lens in the lens array 17, hence a light valve column 18 adjacent to said lens may be opened when the vertical band is illuminated. In other words, the Hybrid Scan Display may be operated as a “rolling backlight” or a “scanning backlight” synchronized with the panel 15. An advantage of this configuration is, that it may be more light efficient than the configurations in FIGS. 12 and 13 while still minimizing crosstalk between observed left and right eye perspective images.

A set of don't-care light valve columns comprising a don't-care light valve column 19 may be calculated as the set of light valve columns being farthest apart from the light valve column 18 so an equal number of light valve columns are open and closed when the set of don't-care light valve columns are opened. For example, the set may be calculated as the number (n/2)−1 of light valve columns being farthest apart from the light valve column 18, where n is the total number of light valves. The set of don't-care light valve columns may be open during a time slot where the light valve column 18 is also open, while the rest of light valve columns may be closed. Hence, since the set of don't-care light valve columns are far apart from the light valve column 18 being illuminated by the LED array 2, illuminated LEDs in the LED array will also be far apart from any open light valve column except the light valve column 18, so there will be no or very few error beams reaching observing eyes. An advantage of this configuration is that during a scan operation there may always be an equal number of light valve columns open and closed, hence DC balance is maintained during the scan period and the duration of the blanking period may be zero. In other words, there may no blanking period needed, and the Hybrid Scan Display can start illuminating a subsequent image being scanned-out on the panel 15 substantially right after the previous image was scanned-out.

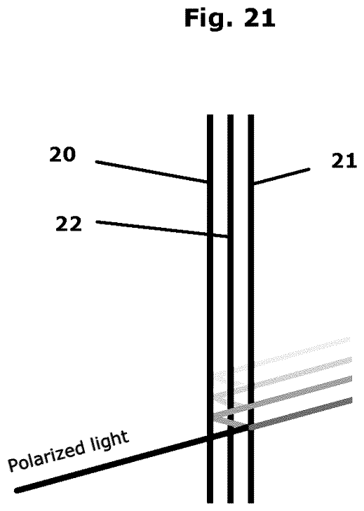

FIG. 21 shows a top view of an additional arrangement, an angle preserving light integrator, which may be located between the Hybrid Scan Display (or any other directional display) having its surface plane parallel to a surface plane of the Hybrid Scan Display, to reduce the visual appearance of seams between lenses or other non-uniformities of the illumination of the image. A first reflective linear polarizer 20 is located between the display and the angle preserving light integrator. The first reflective polarizer may for example be a 3M™ Image Quality Polarizer (IQP). The first reflective polarizer 20 may have a polarization direction allowing polarized light from the display to be transmitted.

A wave retarder plate 22 is located on the side of the first reflective polarizer 20 facing towards an observer. The wave retarder plate 22 may for example be a retarder film or a retarder film stack laminated to the first reflective polarizer. The wave retarder plate 22 may be configured so it rotates the direction of polarized light 45 degrees.

A second reflective linear polarizer 21 is located at the side of the wave retarder plate 22 facing towards an observer. The second reflective polarizer 21 may likewise be a 3M™ Image Quality Polarizer (IQP) and it may be oriented so it reflects most of the polarized light back towards the retarder 22 and transmits a fraction of the light to the side facing an observer. For example, the fraction which is transmitted may be equal to the leakage light of light having an opposite polarization direction than the second reflective polarizer 21, for example the leakage of a 3M™ Image Quality Polarizer (IQP).

Light that is reflected back towards and transmitted through the retarder plate 22 may have it polarization direction rotated 45 degrees. Hence, when the light reaches the first reflective polarizer 20 it may have been rotated 90 degrees since it passed through the first reflective polarizer 20 the first time, and hence the light may be substantially reflected back towards the retarder plate 22, transmitted through this and reflected back by the second reflective polarizer 21. Hence, a fraction may again be transmitted towards an observer, this time at some distance of the light transmitted at the first encounter with the second reflective polarizer, where the distance depends on the angle of incidence of light towards the angle preserving light integrator and of the distance between the two reflecting polarizers. The angle of transmitted light may be substantially preserved.

Hence, several of such light “bounces” may occur, each time with a fraction of the remaining light transmitted towards an observer, and after a number of bounces the transmitted light may have so little optical effect that it is not or barely visible. Hence, for a light beam of a certain width, a smearing of the light beam over a horizontal distance may be observed, while the angular direction of the light is preserved. The width of the smearing will depend on the angle, so that for light having an incident angle of 0 degrees relative to an axis perpendicular to the angle preserving light integrator, may have a width of 0, while for larger angles the width of the smearing is greater. Seams between lenses may be substantially invisible or very low perceptible when the display is observed from an angle of 0 degrees, while it may be visible when viewed from a large angle. Hence, the angle preserving light integrator may smear the visible boundary between two neighboring lenses out when observed from an angle and the boundary may be substantially invisible both when viewed directly from the front and when viewed from an angle.

The smearing width can be adjusted by adjusting by adjusting the distance between the two polarizers and optimized for a pleasant look. If the smearing is too narrow, it may not hide lens seams as well as desired and if it is to big light rays having same angle may emanate at points at too great a distance from each other so they cause crosstalk, e.g. is reaching un intended eye of an observer. Additionally, the second reflective polarizer 21 may be adjusted by rotating it relative to the first reflective polarizer 20 resulting in different fractions of light being transmitted at encounters with the second reflective polarizer 21.

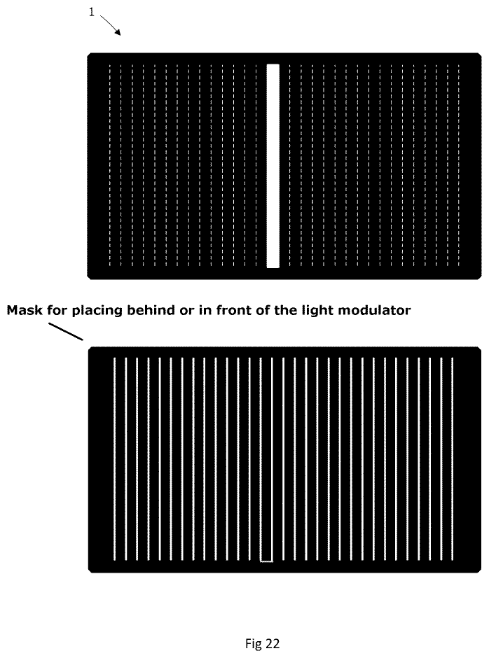

FIG. 22 shows a front view of an example of an aperture mask 23, which may be located in front or behind of the light modulator 1 of the hybrid scan display. The aperture mask 23 may comprise vertical openings having smaller widths than the light valve columns, hence they may have the advantage of focusing light more precisely towards observing eyes accommodating a larger viewing distance. Further, the aperture mask may be made of a non-reflective material, hence reducing reflections of ambient light from a surface of the Hybrid Scan Display.

The aperture mask 23 may be located close to the light modulator 1, for example a distance less than a width of a light valve column in the light modulator 1. The distance between the aperture mask 23 and the light modulator 1 may for example be 0.5 mm. The aperture mask may be made lithographically on a film, or it may be comprised in the light modulator 1 for example as a metal layer similar to metal layers used for example for a black matrix in an lcd display. Alternatively, it could be made of metal, for example a black nickel shim.

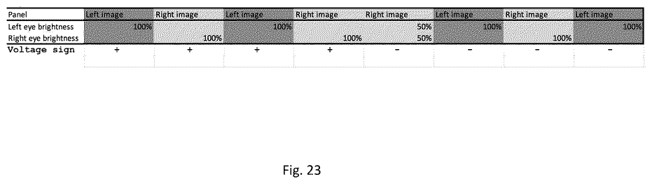

FIG. 23 deals with how to handle DC offset/voltage imbalances over time for the LCD panel.

Liquid crystals may deteriorate if they experience too large a voltage imbalance over time, e.g. if the voltage applied to the crystals have the same polarity/sign all the time.

Thus, it is desirable to avoid such imbalance.

Normally, the polarity could be inverted from frame to frame since two consecutive frames often has images closely related to another—unless in the case where there is a change of scene.

However, this is not necessarily so with a multi view or 3D display. The present disclosure therefore contemplates a new approach.

FIG. 23 shows a sequence of images displayed. In this case a left eye image and a right eye image. The sequence starts with a left eye image which is then followed by a right eye image, which is then followed by a left eye image, e.g. alternating between a left eye image and a right eye image—starting with a left eye image. At the fifth step in the sequence the order is reversed, e.g. a new sequence may begin now starting with the other image than the image that was started with in the previous sequence. This results in a right eye image being displayed twice in a row.

So far, the example shows that the backlight has been at 100% brightness, but at the point in time when the sequence changes the backlight brightness is changed/lowered, e.g. when the second right eye image is displayed after another right eye image has just been displayed (no left eye images displayed in between) it is displayed with a reduced brightness (in the example 50% of the maximum brightness). However, it is contemplated that such reduced brightness may not be necessary, e.g. the two right eye images following each other may be displayed with the backlight having maximum brightness (or at least 80% of maximum brightness).

The second right eye image is displayed to both eyes (both active viewing zones). However, for the other active viewing zone (the left eye in the example) the image is displayed with reduced brightness, such as no more than 80% of maximum brightness (the example shows 50% brightness).

The polarity/sign of the voltage applied across the liquid crystals in the LCD panel 15 are different, e.g. it may be positive before the changed in sequence and negative after as illustrated in the example or it may be negative before and positive after. In this way, a voltage imbalance may be reduced.

### Control of the Display in a Multiview Use

The hybrid scan display/multiview display may comprise an input or be part of a system comprising an input (not shown in the drawings) for inputting which observer is controlling the display, e.g. so an image with control icons is displayed to the correct observer/active viewing zone. Each control icon may activate a function.

The input may be a control icon in an image, e.g. showing an area of the display where the observer/user may touch the display (when the display has touch functionality). When the control icon is touched the system knows which observer wishes to control the display, e.g. the function of the control icon is to flag which observer is now to be a controlling observer such that the display knows who touches the display. This is important, because the display displays a multitude of images to different observers and each image may have different icons with different functions so the display needs to know what the observer is looking at, so it knows which icon is being touch and which function is then to be activated.

An example may be a car situation with a chauffeur and a passenger. The chauffeur may observe a navigation screen and the passenger may observe a movie. In this case the image for the chauffeur may have control icons for controlling the navigation setting, and the image for the passenger may have control icons for controlling the media player, e.g. the display may display a first image for a first active viewing zone and a second image for a second active viewing zone, the first image comprising a first control icon for controlling the display by the first observer and the second image comprising a second control icon for controlling the display by the second observer.

Both images may also comprise the same control icons, such as control icons for climate control. In such a case the first control icon and the second control icon result in the same function being activated.

The input may also be a microphone, such that an observer may tell the display that he/she is now to control the display, e.g. an observer may register with the display who it is that is to control the display. The display may then know that a pressure on the screen comes from a certain observer observing a certain image with a control icon in the position of the pressure/contact (from the finger of the observer).

The input may also be a physical button—one button for the first observer and another button for the second observer so that when that is switched, the display will know if the first or second observer would like to have control.

Or the input may be an icon in the images for the two observers so that when an icon in an image is pressed, the display will know if the first or second observer would like to have control, because each observer only sees his/hers own icon (because the observers are observing different images). All the images may also have an icon for each observer so that each observer can see all icons—including the icons for the other observers.

The input can also be a tracker system, such as a camera or proximity sensor, for detecting or tracking which observer is observing the display. If it is detected that the observer for the first active viewing zone is observing the display, any touch on the display will be associated with the control icons in the image for the first active viewing zone. And vice versa, if it is detected that the observer for the second active viewing zone is observing the display, any touch on the display will be associated with the control icons in the image for the second active viewing zone. It might be that the image for the second active viewing zone also has a control icon at the same area of the display, but the instruction connected to that control icon will not be activated.

The tracker system may also be used to determine from which direction a hand approaches the display, or which hand is touching the display and use that to determine which observer is in the process of touching the display and then know which control icons are relevant, e.g. the controller needs to know if it is a control icon in the image for the first or second active viewing zone that is touched. If it is the observer for the first active viewing zone that is approaching or observing the display, it is a control icon for the first image that is touched. And vice versa, if it is the observer for the second active viewing zone that is approaching or observing the display, it is a control icon for the second image that is touched.

The display may display an image comprising control icons and essential control icons, e.g. controls that activate an essential function for which there is government regulation as to how it is to be controlled. This could be activation of lights or window vipers. Such essential controls may be arranged to be controlled independently of the tracker system or the input. Thus, any touch of an essential control icon will activate the function of the essential control icon.

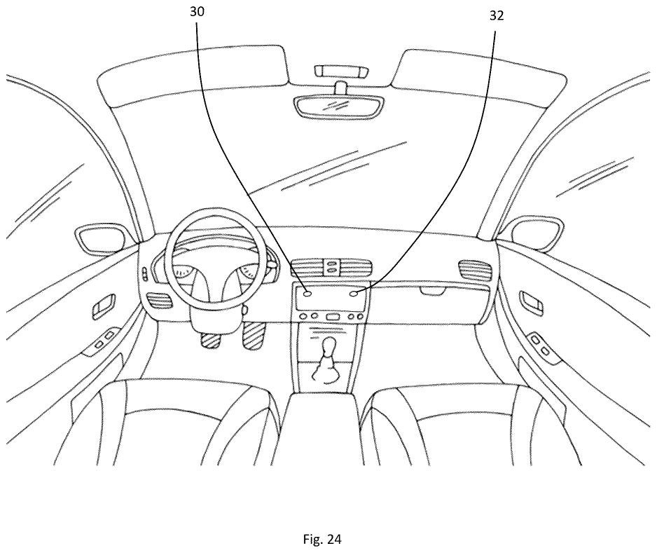

FIG. 24 illustrates an example of a multiview display installed in a car.

The display displays an image comprising a control icon 30 and an essential control icon 32.

The controller may be arranged to control the display such that there will be an (active) viewing zone at the centre of the display, e.g. a viewing zone covering the angles +/−25 or +/−20 or +/−15 or +/−10 or +/−5 degrees with respect to the normal of the display, which will display the same image as the first viewing zone when the observer in the first viewing zone approaches the display. For example, there may be a third viewing zone arranged between the first viewing zone and the second viewing zone. The image in this viewing zone will be the same as the one in the first viewing zone when the first observer leans/moves towards the display. And the image in that viewing zone will be the same as the one in the second viewing zone when the second observer leans/moves towards the display. The first viewing zone may be to the right (at a right-hand side) of the display and the second viewing zone may be at a left-hand side of the display. Alternatively, the first viewing zone may be at a left-hand side of the display and the second viewing zone may be at a right hand side of the display.

The tracker system may be used to determine if the observer in one of the viewing zones approaches the display.

Alternatively, when the observer in the first viewing zone approaches the display, the same image may be displayed in the first viewing zone and the second viewing zone. Or vice versa, when the observer in the second viewing zone approaches the display, the same image may be displayed in the first viewing zone and the second viewing zone.

Approaching means that the nose of an observer comes closer to the centre of the display, for example the observer moves his/her head in a plane parallel to the display or along a line directly towards the display.

The normal vector, often simply called the “normal,” to a surface, is a vector which is perpendicular to the surface at a given point.

### Temperature Dependent Operation

Below a certain temperature threshold, such as 15 degrees Celsius or 10 or 5 or 0 degrees Celsius, it is contemplated that the display may switch to 2D operation, e.g. the controller receives input from a temperature sensor in order to control the display.

Below the temperature threshold, the liquid crystal cells could all be open—they are all in the light transmitting state and all the LEDs may generate an image visible through the liquid crystals, e.g. such that there is no modulation by the liquid crystals.

To avoid DC imbalance/offset in the crystals, they may all be closed in the same amount of time as they were open, e.g. they alternate between being open and closed substantially simultaneously (within a time window). And when they are open, an image is generated and this image is visible as a 2D image in all viewing zones (because there is no modulation by the crystals).

In the case that the hybrid scan display operates as a backlight for a LCD panel, it is contemplated that below the temperature threshold, a non-directional backlight is generated, e.g. in the same way as above, the crystals are all open and do not provide any modulation below the temperature threshold. When this is the case, the image generated by the LCD panel will be observed as a 2D image in all viewing zones.

Further, below a certain temperature threshold, a heating operation of the light modulator may be initiated. Such heating operation may comprise heating an ITO layer or other conducting layer in the light modulator, for example by inducing a (dc) current through the layer for example by applying a voltage difference to opposing ends of the layer or by applying an AC voltage across liquid crystal cells in the light modulator, said AC voltage preferably having a frequency being high relative to an RC component of opposing cell electrodes, hence inducing a high current.

A temperature sensor may be provided with the display to measure the temperature of the environment, such as the air temperature, or some other temperature of a component of the display.

As for the situation where too many observers are observing the display, the driving signal for the light modulators may comprise a high frequency, such as 5 or 10 or 20 or 30 or 40 kHz, such that the light modulators enters into a semi-transparent state. This will allow for a (2D) image to be transmitted through the light modulators. This can be used in cold conditions, e.g. below a temperature threshold as the one mentioned above.

Now follows a set of items, which constitute aspects of the present disclosure which may be considered independently patentable and as such the following sets form basis for possible future sets of claims:

1. A hybrid scan display for emitting light to a plurality of active viewing zones including a first active viewing zone and a second active viewing zone, said hybrid scan display comprising:
a plurality of light emitters for emitting light,
a plurality of light modulators, such as liquid crystal cells,
each light modulator switching between two states including a light transmitting state for transmitting light from said plurality of light emitters or a light shielding state for shielding light from said plurality of light emitters.

A hybrid scan display for emitting light to a plurality of active viewing zones including a first active viewing zone and a second active viewing zone, said hybrid scan display comprising:
a number of modules including at least one module and preferably a plurality of modules, each module having:
a plurality of light emitters preferably arranged in columns for emitting light,
a plurality of light modulators, such as liquid crystal cells,
said plurality of light emitters divided into in a first set of logical modules constituting a set of light emitter modules, and
said plurality of light modulators divided into in a second set of logical modules constituting aperture modules,
each light modulator switching between two states including a light transmitting state for transmitting light from said plurality of light emitters and a light shielding state for shielding light from said plurality of light emitters.

2. The hybrid scan display according to any of the preceding items, comprising
a LCD panel for displaying an image,
said LCD panel arranged in front of said plurality of light emitters,
said plurality of light modulators arranged between said plurality of light emitters and
said LCD panel.

3. The hybrid scan display according to any of the preceding items,
said plurality of light emitters comprising vertically elongated light emitters.

4. The hybrid scan display according to any of the preceding items,
said LCD panel alternating between generating an image for a first active viewing zone and a second active viewing zone.

5. The hybrid scan display according to any of the preceding items,
said controller arranged for scanning said liquid crystal cells in each aperture module in a sequence such that each liquid crystal cell having been open once creating an effect of a moving aperture through each aperture module during a multiplexing cycle such that a first aperture module having a first moving aperture and a second aperture module having a second moving aperture,
when said first active viewing zone having an angle greater than 10 degrees with respect to the normal of said display said controller arranged for scanning a respective column of light emitters behind said first aperture module such that light emitted by said respective column of light emitters being visible at said active viewing zone through said second moving aperture.

With logical modules is meant that manufacturing wise the display may be manufactured with a layer in one piece of light emitters and a layer in one piece of liquid crystals, e.g. a number of smaller physical modules are not manufactured one by one and then assembled to one large display. Instead, the controller controls the light emitters and liquid crystals in modules operating in parallel to each other. In this way the number of columns of light emitters in the light emitter modules may vary depending on the position of active viewing zones, and light emitter modules may share light emitters, e.g. light emitters arranged behind the boundary zone between two aperture modules may be shared between two light emitter modules.

6. The hybrid scan display according to any of the preceding items,
said liquid crystal cells arranged for operating in binary mode.

7. The hybrid scan display according to any of the preceding items,
said LCD panel arranged for generating a first image for a first active viewing zone and a second image for a second active viewing zone during a multiplexing cycle,
said LCD panel including a plurality of light modulators, such as liquid crystals, arranged in columns and updated with image pixel values a number of columns at a time,
said hybrid scan display comprising a controller for scanning said plurality of liquid crystal cells such that each liquid crystal cell having been open once creating an effect of a moving aperture during said multiplexing cycle,
said plurality of light emitters and said liquid crystals scanned such that
when a column of light modulators being substantially fully updated with image pixel values of said first image said backlight emitting light towards said column such that the image pattern generated by said column being visible at said first active viewing zone, and
when a column of light modulators being substantially fully updated with image pixel values of said second image said backlight emitting light towards said column such that the image pattern generated by said column being visible at said second active viewing zone.

8. The hybrid scan display according to any of the preceding items,
each liquid crystal cell switching between two states including a light transmitting state for transmitting light from said plurality of vertically elongated light emitters or a light shielding state for shielding light from said plurality of light guides.

9. The hybrid scan display according to any of the preceding items,
each liquid crystal cell arranged for being operated in binary mode such that each liquid crystal cell exclusively switching between said light transmitting state and said light shielding state.

10. The hybrid scan display according to any of the preceding items,
a column of light modulators being substantially fully updated when having reached at least 80% of an image pixel value.

11. The hybrid scan display according to any of the preceding items,
said light emitters arranged in columns with preferably more than one light emitter in each column.

12. The hybrid scan display according to any of the preceding items,
each liquid crystal cell defining an aperture in said light transmitting state.

13. The hybrid scan display according to any of the preceding items,
comprising a controller arranged for scanning said light emitters and said liquid crystal cells during a multiplexing cycle for displaying a plurality of images including a first image to said first active viewing zone and a second image to said second active viewing zone.

14. The hybrid scan display according to any of the preceding items,
said hybrid scan display including a controller arranged such that
said hybrid scan display displaying a first image for a first active viewing zone while said backlight emitting light at a brightness of at least 80% of the maximum brightness towards said first active viewing zone,
said hybrid scan display displaying a second image for a second active viewing zone while said backlight emitting light at a brightness of at least 80% of the maximum brightness towards said second active viewing zone,
said hybrid scan display displaying a third image for said second active viewing zone while said backlight emitting light at a brightness of at least 80% of the maximum brightness or alternatively no more than 80% of the maximum brightness towards said second active viewing zone,
said hybrid scan display displaying said third image for said first active viewing zone while said backlight emitting light at a brightness of no more than 80% of the maximum brightness towards said first active viewing zone.

15. The hybrid scan display according to any of the preceding items,
said hybrid scan display displaying a fourth image for said first active viewing zone while said backlight emitting light at a brightness of at least 80% of the maximum brightness, said fourth image displayed after said third image.

16. The hybrid scan display according to any of the preceding items,
said LCD panel comprising liquid crystals with a first voltage applied when said first image and said second image being displayed, and a second voltage applied when said third image being displayed, said second voltage preferably having an opposite sign compared to said first voltage.

17. The hybrid scan display according to any of the preceding items,
said hybrid scan display including a controller arranged such that
said hybrid scan display having a sequence alternating between displaying images for a first active viewing zone and a second active viewing zone,
a respective image for said second active viewing zone being displayed as the next image after a respective image for said first active viewing zone have been displayed, said controller arranged such that
at a point in time said sequence comprising an image being displayed for said first active viewing zone and for said second active viewing zone.

18. The hybrid scan display according to any of the preceding items,
for one of said two images displayed for said first active viewing zone said backlight having a reduced brightness compared to a brightness of said backlight for the other one of said two images.

19. The hybrid scan display according to any of the preceding items,
said LCD panel comprising liquid crystals with a first voltage having a first sign applied before said point in time and a second voltage having a second sign applied after said point in time, said first sign preferably being opposite said second sign.

20. The hybrid scan display according to any of the preceding items,
said number of modules including a first module and a second module,
said controller arranged for scanning said first module and said second module in parallel during a multiplexing cycle such that
said first plurality of light emitters being scanned in a first sequence, and said second plurality of light emitters being scanned in a second sequence different from said first sequence.

21. The hybrid scan display according to any of the preceding items,
said controller arranged for determining when said first sequence and said second sequence causing a view crash causing a first observer observing part of an image intended for a second observer.

22. The hybrid scan display according to any of the preceding items,
said second sequence being a function of said first sequence for reducing view crash between active viewing zones.

23. The hybrid scan display according to any of the preceding items,
said controller arranged for changing said second sequence when a view crash being determined for avoiding or minimizing the occurrence of view crash.

24. The hybrid scan display according to any of the preceding items,
said plurality of liquid crystal cells including a range of 8 to 80, such as 8 to 60 or 20 to 40 liquid crystal cells, for balancing view crash reduction and peak brightness of said display.

25. The hybrid scan display according to any of the preceding items,
comprising an observer tracker for tracking the position of an observer in front of said display.

26. The hybrid scan display according to any of the preceding items,
said controller arranged for scanning said liquid crystal cells in a sequence such that each liquid crystal cell having been open once creating an effect of a moving aperture during a multiplexing cycle.

27. The hybrid scan display according to any of the preceding items,
said controller arranged for dividing each image into a sequence of image parts,
each image part constituting a single column of pixels of said image,
the plurality of sequences of image parts being interleaved into an interleaved sequence.

28. The hybrid scan display according to any of the preceding items,
said interleaved sequence defining the multiplexing ratio preferably excluding a blanking period. 29. The hybrid scan display according to any of the preceding items,
a single image part of an image being displayed per module when a liquid crystal cell being in said light transmitting state, and a respective column preferably emitting a light pattern defined by a respective single image part in each step in said multiplexing cycle.

30. The hybrid scan display according to any of the preceding items,
each liquid crystal cell having been open in a time interval including at least two steps of said multiplexing cycle such that at least two columns having flashed light when a respective liquid crystal cell having been open.

31. The hybrid scan display according to any of the preceding items,
said first column emitting a light pattern a number of times corresponding to the number of active viewing zones while a number of liquid crystal cells corresponding to the number of active viewing zones being addressed in a sequence such that a light pattern is emitted to each active viewing zone.

32. The hybrid scan display according to any of the preceding items,
said display arranged such that said light pattern being delimited by liquid crystal cells adjacent said moving aperture such that
only a part of the light rays of said light pattern having a line of sight to said first active viewing zone reaching said first active viewing zone.

33. The hybrid scan display according to any of the preceding items,
said light pattern being delimited by liquid crystal cells being neighbors to the respective liquid crystal cell being open at a step in said multiplexing cycle.

34. The hybrid scan display according to any of the preceding items,
said controller arranged for selecting a set of columns for emitting light during a multiplexing cycle,
said set emitting light such that light from a first edge of said set being blocked by a liquid crystal cell and light from the centre of said set being transmitted through said liquid crystal cell when said liquid crystal cell being in said light transmitting state.

35. The hybrid scan display according to any of the preceding items,
said set comprising a second edge opposite said first edge and said set emitting light such that light from said second edge being blocked by said liquid crystal cell.

36. The hybrid scan display according to any of the preceding items,
said light emitters arranged in columns including a first column.

37. The hybrid scan display according to any of the preceding items,
said liquid crystal cells including a first liquid crystal cell and a second liquid crystal cell.

38. The hybrid scan display according to any of the preceding items,
said controller arranged for scanning said columns in a second sub-sequence including said first column for emitting light when said second liquid crystal cell being in said light transmitting state,
between said first column being scanned in said first sub-sequence and in said second sub-sequence a second number of columns being scanned such that said first column having a pause between emitting light when scanned in said first sub-sequence and in said second sub-sequence.

39. The hybrid scan display according to any of the preceding items,
said controller arranged for scanning said columns in a first sub-sequence including said first column,
said first sub-sequence defining a first number of pixel value updates to said columns such that a plurality of sets of said columns emitting light when said first liquid crystal cell being in said light transmitting state.

40. The hybrid scan display according to any of the preceding items,
said first number being greater than one and less than the number of said columns.

41. The hybrid scan display according to any of the preceding items,
said controller arranged for updating two neighboring columns adjacent each other with pixel values such that
each of said two neighboring columns being updated with pixel values of a single column of pixels of said image such that
each of said two neighboring columns emitting substantially the same light pattern as the other.

42. The hybrid scan display according to any of the preceding items,
said controller arranged such that
when said moving aperture changing to a new position from a previous position said controller switching on a first plurality of columns of light emitters for emitting light to active viewing zones, and switching off a second plurality of columns previously being switched on for said previous position such that said second plurality of columns being off during said moving aperture being at said new position for an increased signal to noise ratio.

If columns that had been on/emitting light just before the moving aperture moved to a new position were not switched off there would be a higher risk of cross talk and the contrast ratio (signal to noise ratio) would be so low that the picture quality would be very low or at least not at the same level as a standard LCD display anno 2024 for example. There would also be a risk of overheating the light emitters, because they would risk being on too long time at a time.

43. The hybrid scan display according to any of the preceding items, comprising
an aperture mask
preferably arranged such that each aperture in said aperture mask being more narrow than each liquid crystal cell such that
the pixel width of said display being defined by the width of the apertures in said aperture mask,
said aperture mask preferably arranged in front or behind said liquid crystal cells.

An advantage of such an aperture mask is that light may be focused more precisely at a greater distance without having to increase the number of apertures/liquid crystals that needs to be scanned.

44. The hybrid scan display according to any of the preceding items, comprising
A lens, such as a cylinder or semi-cylinder or acylindrical lens, adjacent each liquid crystal.

Such cylinders theoretically focuses light to a one dimensional line compared to a round lens focusing to a point.

45. The hybrid scan display according to any of the preceding items,
said lens being elongated and having a longitudinal axis parallel with the longitudinal axis of a liquid crystal cell.

46. The hybrid scan display according to any of the preceding items, comprising
a second plurality of liquid crystal cells,
each liquid crystal cell switching between two states including a light transmitting state for transmitting light from said plurality of light emitters or a light shielding state for shielding light from said plurality of light emitters,
said second plurality of liquid crystal cells arranged between said plurality of light emitters and said first plurality of liquid crystal cells.

47. The hybrid scan display according to any of the preceding items,
each liquid crystal cell of said second plurality of liquid crystal cells having a width greater than the width of said first liquid crystal cell, and/or
at least two neighboring liquid crystal cells of said second plurality of liquid crystal cells being in said light transmitting state at a point in time during a multiplexing cycle.

48. The hybrid scan display according to any of the preceding items,
said controller arranged for selecting a set of liquid crystal cells of said second plurality of liquid crystal cells for being in said light transmitting state at a point in time during a multiplexing cycle,
said set being selected as a function of said first liquid crystal cell, and
said first active viewing zone or
the horizontal viewing angle of said hybrid scan display.

49. A system comprising a multiview display, such as the hybrid scan display according to any of the preceding items, for displaying a first image in a first viewing zone for a first observer and displaying a second image in a second viewing zone for a second observer, said first viewing zone preferably arranged at a right hand side of said multiview display and said second viewing zone preferably arranged at a left hand side of said multiview display or vice versa, said system comprising:
an input for inputting when said first observer or when said second observer is a controlling observer of said multiview display.

50. The system according to any of the preceding items, said system comprising:
a controller arranged for controlling said multiview display such that said first image comprising a first control icon for said first observer and said second image comprising a second control icon for said second observer, and
when inputting said first observer as said controlling observer and said first control icon being touched a first function being activated, and
when inputting said second observer as said controlling observer and said second control icon being touched a second function being activated, said first function preferably being different from said first function.

51. The system according to any of the preceding items, said system comprising:
a controller arranged for controlling said multiview display such that said multiview display displays an image comprising a control icon and an essential control icon, and when touching said essential control icon an essential function being activated independently of said input.

52. The system according to any of the preceding items, said system comprising:
a controller arranged for controlling said multiview display such that
when said first observer approaching said multiview display said controller arranged for controlling said multiview display such that said multiview display displays said first image for said first viewing zone and for said second viewing zone or for a third viewing zone between said first viewing zone and said second viewing zone, or
when said second observer approaching said multiview display said controller arranged for controlling said multiview display such that said multiview display displays said second image for said first viewing zone and for said second viewing zone or for a third viewing zone between said first viewing zone and said second viewing zone.

53. A 3D display, such as the hybrid scan display according to any of the preceding items, for displaying 3D content to a plurality of observers, said 3D display comprising:
a plurality of light modulators, such as liquid crystal cells,
a controller for controlling said plurality of light modulators,
a tracker for tracking the number of observers,
said controller arranged such that
when the number of observers exceeds a threshold, such as 4 observers, or
when the temperature of said 3D display being less than a temperature threshold, such as 15 degrees Celsius,
said controller driving said plurality of light modulators at a frequency higher than 10 kHz or 20 kHz or 30 kHz such that said plurality of light modulators being in a semi transparent state and said 3D display displaying a 2D image preferably to all observers.

In the hybrid scan display the light modulators switches between two states at a high frequency. However, there are limits as to how many observers, such as a hybrid scan display or any other 3D display, may support, e.g. display 3D content to. At too low temperatures, such as below 15 degrees Celsius or 10 or 0, the light modulators may loose their ability to support even 2 observers for 3D, and in general it may be that there are too many observers. The voltage across the light modulators can not be removed, because the light modulators will become uneven or distorted. Instead a very high frequency can be applied to the light modulators where it will be possible to transmit light through them and display, albeit a 2D, image to the observers.

Applying such an alternating driving signal to the display also heats up the light modulators—the alternating current of the driving signal will due to an RC component of the electrodes between the light modulators heat up the electrodes and thereby the light modulators. This may cause the display to be able to quicker be able to show 3D in cold temperatures.

54. The hybrid scan display according to any of the preceding items,
comprising a blanking mode as part of a multiplexing cycle wherein said plurality of light emitting diodes emitting no light while said plurality of ferro-electric liquid crystal cells being open in a time window, said time window preferably being less than 20 milliseconds, such as less than 10 milliseconds.

55. The hybrid scan display according to any of the preceding items,
for each liquid crystal cell a voltage being applied across it by means of a pair of electric terminals including a first electric terminal connected to a ground plane via a return path,
said ground plane held at a first voltage when scanning said liquid crystal cells in said sequence and at a second voltage different from said first voltage during a blanking period.

Since all apertures/liquid crystals is set to the same DC offset/voltage applied across each cell (because they are only instructed to open and close and not have a specific grey scale value as in an LCD panel for generating an image) they may all be opened simultaneously during the blanking period (=when backlight/light emitters all are turned off for a short time span), and because all liquid crystals are open for the same amount of time during the scan sequence, and an opposite DC offset (compared to the one applied in the MP cycle) may be applied for balancing/achieving a time integrated offset of 0 V.

It is also possible to increase the voltage applied (across the cells) during the blanking period/mode, because the common/ground electrode may be shifted (ground plane potential shifted). A higher voltage applied during the blanking period than in the duty cycle, e.g. when the light emitters are not turned off as in the blanking period, may also decrease the duration of the blanking period.

The multiplexing period may comprise a duty cycle/scan sequence (where the images for the active view zones are generated) and the blanking period. In some cases in the present disclosure the multiplexing cycle is referred to without a blanking period since a blanking period is optional.

As an example, during the duty cycle/scanning of the liquid crystals the electrodes connected to common ground may be set to zero volt. For closing a liquid crystal cell a voltage of −X (such as −7 volt) is applied (to the other terminal, than ground, of each cell to be closed) and +X volt (such as +7) to the one(s) that should open.

In the blanking period the common ground may be set to −7 volt and +7 volt applied to all cells giving a voltage of 14 across each cell—double of the potential during scanning. 56. A display for displaying digital images directed to a first viewing region and a second viewing region, said autostereoscopic or multi-view display comprising:
a plurality of light emitters,
a plurality of liquid crystal cells including a first liquid crystal cell switching between two states including a light transmitting state for transmitting light from said plurality of light emitters or a light shielding state for shielding light from said plurality of light emitters,
each liquid crystal cell defining an aperture in said light transmitting state,
said plurality of light emitters arranged in vertical columns including a first vertical column of light emitters and a second vertical column of light emitters.

57. The display according to any of the preceding items,
each light emitter being a light emitting diode.

58. The display according to any of the preceding items,
each liquid crystal cell being a ferro-electric liquid crystal cell, and preferably operated in binary mode.

59. The display according to any of the preceding items, comprising a controller for controlling said plurality of light emitting diodes as a function of said first viewing region and said second viewing region
such that said first vertical column generating a first light flash and said second vertical column generating a second light flash when said first ferro-electric liquid crystal cell being in said light transmitting state
such that said first light flash being visible at said first viewing region, and
said second light flash being visible at said second viewing region.

60. The display according to any of the preceding items, said second vertical column generating said second light flash after said first light flash.

61. The display according to any of the preceding items,
said controller configured for controlling said plurality of light emitting diodes as a function of a third viewing region and a fourth viewing regions such that a first pair of vertical columns are scanned substantially at the same time before a second pair of vertical columns are scanned substantially at the same time for directing a first image to said first and third viewing region and a directing a second image to said second and fourth viewing region.

62. The display according to any of the preceding items,
comprising a diffuser between said vertical columns and said plurality of vertical ferro-electric liquid crystal cells or
configured such that light transmitted through a ferro-electric liquid crystal cell having a light intensity being a function of
the position of the brightness centroid in a horizontal plane of a ferro-electric liquid crystal cell and
two pixels of said digital image.

63. The display according to any of the preceding items,
configured such that light transmitted through at least 50% or 70% of said ferro-electric liquid crystal cells having a light intensity being a function of
the position of the brightness centroid in a horizontal plane of a ferro-electric liquid crystal cell and
two pixels of said digital image.

64. The display according to any of the preceding items,
said diffuser configured such that each ferro-electric liquid crystal cell having a light intensity with a brightness centroid substantially in the centre of said cell when transmitting light through said cell.

65. The display according to any of the preceding items,
said plurality of light emitting diodes having a passive matrix addressing. 66. The display according to any of the preceding items,
said display being an autostereoscopic or multi-view display or hybrid scan display. 67. The display according to any of the preceding items,
comprising an observer tracking for determining said first viewing region and said second viewing region.

68. The display according to any of the preceding items,
each ferro-electric liquid crystal cell having a height and a width, said height being greater than said width.

69. The display according to any of the preceding items being a time-multiplexed display.

70. The display according to any of the preceding items, said plurality of light emitting diodes constituted by discrete inorganic light emitting diodes or an OLED layer.

71. The display according to any of the preceding items, said plurality of light emitting diodes being pulsed.

72. The display according to any of the preceding items,
comprising directional light emitters, said directional light emitters preferably configured forproviding an angular resolution of viewing regions in the vertical direction.

73. The display according to any of the preceding items,
having a mode for presenting 2D single view images where substantially all liquid crystal cells are in a light transmitting state and a 2D image is displayed by said plurality of light emitting diodes.

74. The display according to any of the preceding items,
comprising a second ferro-electric liquid crystal cell being open for transmitting light through said second first ferro-electric liquid crystal cell to a viewing region without observers for extending the time said plurality of ferro-electric liquid crystal cells being open during a multiplexing cycle, said second ferro-electric liquid crystal cell constituting a don't care ferro-electric liquid crystal cell.

75. The display according to any of the preceding items where said plurality of ferro electric liquid crystal cells are switched sequentially during a duty cycle one by one from a light shielding state to a light transmitting state and where said plurality of liquid crystal cells comprises a number of liquid crystal cells corresponding to a number of states in a duty cycle and where the number of states in the duty cycle is greater than two, preferably greater than 4, such as 16, such as 32.

76. A hybrid scan display for emitting light to a plurality of active viewing zones including a first active viewing zone, said display comprising:
a plurality of light emitters for emitting light,
said plurality of light emitters arranged in columns,
a plurality of liquid crystal cells,
each liquid crystal cell switching between two states including a light transmitting state for transmitting light from said plurality of light emitters or a light shielding state for shielding light from said plurality of light emitters,
a controller for scanning said plurality of liquid crystal cells in a sequence such that each liquid crystal cell having been open once creating an effect of a moving aperture during a multiplexing cycle,
said controller scanning said columns and said plurality of liquid crystal cells during said multiplexing cycle for displaying a plurality of images,
each image divided into a sequence of image parts,
each image part constituting a single column of pixels of said image,
the plurality of sequences of image parts being interleaved into an interleaved sequence defining the multiplexing ratio excluding a blanking period,
a single image part of an image being displayed when a liquid crystal cell being in said light transmitting state, and a respective column emitting a light pattern defined by a respective single image part in each step in said multiplexing cycle,
said display arranged such that said light pattern being delimited by liquid crystal cells adjacent said moving aperture such that
only a part of the light rays of said light pattern having a line of sight to said first active viewing zone reaching said first active viewing zone.

77. A hybrid scan display comprising:
a plurality of light emitters for emitting light,
said plurality of light emitters arranged in columns including a first column,
a plurality of liquid crystal cells including a first liquid crystal cell and a second liquid crystal cell,
each liquid crystal cell switching between two states including a light transmitting state for transmitting light from said plurality of light emitters or a light shielding state for shielding light from said plurality of light emitters,
a controller for scanning said columns in a first sub-sequence defining a first number of pixel value updates to said columns such that a plurality of sets of said columns emitting light when said first liquid crystal cell being in said light transmitting state,
said first number being greater than one and less than the number of said columns,
said controller scanning said columns in a second sub-sequence including said first column for emitting light when said second liquid crystal cell being in said light transmitting state,
between said first column being scanned in said first sub-sequence and in said second sub-sequence a second number of columns being scanned such that said first column having a pause between emitting light when scanned in said first sub-sequence and in said second sub-sequence.

78. A hybrid scan display comprising:
a plurality of light emitters for emitting light,
said plurality of light emitters arranged in columns,
a first plurality of liquid crystal cells and a second plurality of liquid crystal cells,
each liquid crystal cell switching between two states including a light transmitting state for transmitting light from said plurality of light emitters or a light shielding state for shielding light from said plurality of light emitters,
said second plurality of liquid crystal cells arranged between said plurality of light emitters and said first plurality of liquid crystal cells,
a controller for scanning said columns and said plurality of liquid crystal cells during a multiplexing cycle for generating a plurality of images,
each image divided into a sequence of image parts,
the plurality of sequences of image parts being interleaved into an interleaved sequence defining the length of said multiplexing cycle excluding a blanking period,
said controller scanning said first plurality of liquid crystal cells in a sequence such that each liquid crystal cell having been open once creating an effect of a moving aperture during said multiplexing cycle,
the number of columns being scanned when each liquid crystal cell being in said light transmitting state being greater than one and less than the number of said columns.

79. A hybrid scan display including a first module and a second module,
said first module comprising:
a first plurality of light emitters arranged in vertical columns,
a first plurality of liquid crystal cells,
said second module comprising:
a second plurality of light emitters arranged in vertical columns,
a second plurality of liquid crystal cells,
each liquid crystal cell switching between two states including a light transmitting state for transmitting light from said plurality of light emitting diodes and a light shielding state for shielding light from said plurality of light emitting diodes,
a controller for scanning said first module and said second module in parallel during a multiplexing cycle such that
said first plurality of light emitters being scanned in a first sequence, and said second plurality of light emitters being scanned in a second sequence different from said first sequence.

80. A hybrid scan display including a plurality of modules,
each module comprising:
a plurality of light emitters for emitting light,
a plurality of liquid crystal cells,
each liquid crystal cell switching between two states including a light transmitting state for transmitting light from said plurality of light emitting diodes and a light shielding state for shielding light from said plurality of light emitting diodes,
each liquid crystal cell defining an aperture in said light transmitting state,
said plurality of liquid crystal cells including a range of 8 to 80, such as 8 to 60 or 20 to 40 liquid crystal cells, for balancing view crash reduction and peak brightness of said display.

81. A hybrid scan display for displaying digital images directed to a plurality of active viewing zones, said hybrid scan display including a first module and a second module,
said first module comprising:
a first plurality of light emitters for emitting light,
a first plurality of liquid crystal cells,
said second module comprising:
a second plurality of light emitters for emitting light,
a second plurality of liquid crystal cells,
each liquid crystal cell switching between two states including a light transmitting state for transmitting light from said plurality of light emitting diodes and a light shielding state for shielding light from said plurality of light emitting diodes,
each liquid crystal cell defining an aperture in said light transmitting state,
said hybrid scan display comprising a controller for scanning said first plurality of liquid crystal cells in a first sequence and scanning said second plurality of liquid crystal cells in a second sequence, said second sequence being a function of said first sequence for reducing view crash between active viewing zones.

82. The hybrid scan display according to any of the preceding items, comprising observer tracking for tracking the position of an observer in front of said autostereoscopic or multi-view display.

83. The hybrid scan display according to any of the preceding items, said controller configured to determine if said first sequence and said second sequence causing a view crash such that one observer observes part of an image intended for another observer.

84. The hybrid scan display according to any of the preceding items, said controller configured for changing said second sequence when a view crash being determined for avoiding or minimizing the occurrence of view crash.

85. A hybrid scan display for displaying digital images directed to a plurality of active viewing zones including a first active viewing zone, said hybrid scan display comprising:
a plurality of light emitters for emitting light,
a first plurality of liquid crystal cells including a first liquid crystal cell and a second plurality of liquid crystal cells,
each liquid crystal cell switching between two states including a light transmitting state for transmitting light from said plurality of light emitting diodes and a light shielding state for shielding light from said plurality of light emitting diodes,
each liquid crystal cell of said first plurality of liquid crystal cells defining an aperture in said light transmitting state,
said second plurality of liquid crystal cells arranged between said plurality of light emitters and said first plurality of liquid crystal cells.

86. The hybrid scan display according to any of the preceding items,
each liquid crystal cell of said second plurality of liquid crystal cells having a width greater than the width of said first liquid crystal cell, and/or
at least two neighboring liquid crystal cells of said second plurality of liquid crystal cells being in said light transmitting state at a point in time during a multiplexing cycle.

87. The display according to any of the preceding items, comprising:
a controller for selecting a set of liquid crystal cells of said second plurality of liquid crystal cells for being in said light transmitting state at a point in time during a multiplexing cycle,
said set being selected as a function of said first liquid crystal cell, and
said first active viewing zone or
the horizontal viewing angle of said hybrid scan display.

88. The display according to any of the preceding items,
said controller arranged for selecting a set of columns for emitting light during a multiplexing cycle,
said set emitting light such that light from a first edge of said set being blocked by a liquid crystal cell and light from the centre of said set being transmitted through said liquid crystal cell when said liquid crystal cell being in said light transmitting state.

89. The display according to any of the preceding items,
said set emitting light such that light from a second edge opposite said first edge being blocked by said liquid crystal cell.

1. A hybrid scan display for emitting light to a plurality of active viewing zones including a first active viewing zone and a second active viewing zone, the hybrid scan display comprising:
a plurality of modules, each module having:
a plurality of light emitters for emitting light,
a plurality of light modulators,
each light modulator switching between two states including a light transmitting state for transmitting light from the plurality of light emitters or a light shielding state for shielding light from the plurality of light emitters; and
a controller arranged for scanning of a moving aperture during a multiplexing cycle, the controller arranged for scanning the light emitters and the light modulators during the multiplexing cycle for displaying a plurality of images including a first image to the first active viewing zone and a second image to the second active viewing zone, the controller arranged for dividing each image into a sequence of image parts, each image part constituting a single column of pixels of the image, the sequence of image parts of each image being interleaved into an interleaved sequence, a single image part of an image being displayed when a light modulator is in the light transmitting state.

2. A hybrid scan display for emitting light to a plurality of active viewing zones including a first active viewing zone and a second active viewing zone, said the hybrid scan display comprising:
a plurality of light emitters for emitting light;
a plurality of light modulators;
each light modulator switching between two states including a light transmitting state for transmitting light from the plurality of light emitters, or a light shielding state for shielding light from the plurality of light emitters; and
an LCD panel for displaying an image, the LCD panel arranged in front of the plurality of light emitters, the plurality of light modulators arranged between the plurality of light emitters and the LCD panel, the plurality of light emitters comprising vertically elongated light emitters, the LCD panel alternating between generating an image for a first active viewing zone and a second active viewing zone.

3. The hybrid scan display according to claim 2, further comprising
a controller arranged for scanning the light modulators in a sequence such that each light modulator having been open once creates an effect of a moving aperture during a multiplexing cycle.

4. The hybrid scan display according to claim 2, wherein:
the LCD panel is arranged for generating a first image for the first active viewing zone and a second image for the second active viewing zone during a multiplexing cycle,
the LCD panel comprises a second plurality of light modulators arranged in columns and updated with image pixel values a number of columns at a time,
the plurality of light emitters and the second plurality of light modulators are scanned such that:
when a column of light modulators is substantially fully updated with image pixel values of the first image, the plurality of light emitters emit light towards the column such that the image generated by the column is visible at the first active viewing zone, and
when a column of light modulators is substantially fully updated with image pixel values of the second image, the plurality of light emitters emit light towards the column such that the image generated by the column is visible at the second active viewing zone.

5. The hybrid scan display according to claim 1, wherein the plurality of light modulators are arranged for operating in binary mode.

6. The hybrid scan display according claim 1, wherein:
the plurality of light emitters comprises a first plurality of light emitters and a second plurality of light emitters,
the plurality of modules comprises a first module and a second module, and
the controller is arranged for scanning the first module and the second module in parallel during a multiplexing cycle such that the first plurality of light emitters is scanned in a first sequence and the second plurality of light emitters is scanned in a second sequence that is different from the first sequence.

7. The hybrid scan display according to claim 6, wherein the controller is arranged for determining when the first sequence and the second sequence cause a view crash that causes a first observer observing part of an image intended for a second observer.

8. The hybrid scan display according to claim 7, the second sequence being a function of the first sequence for reducing the view crash between active viewing zones.

9. The hybrid scan display according to claim 6, the controller arranged for changing the second sequence when a view crash being determined for avoiding or minimizing an occurrence of view crash.

10. A system including a multiview display for displaying a first image in a first viewing zone for a first observer, and a second image in a second viewing zone for a second observer, the system comprising:
an input for inputting when the first observer or when the second observer is a controlling observer of the multiview display; and
a controller arranged for controlling the multiview display, such that the multiview display displays an image comprising a control icon and an essential control icon, and when the essential control icon is actuated, an essential function is activated independently of the input.

11. The hybrid scan display according to claim 2, wherein the plurality of light modulators are arranged for operating in binary mode.

12. The hybrid scan display according to claim 1, wherein the plurality of light modulators comprises a plurality of liquid crystal cells.

13. The hybrid scan display according to claim 2, wherein the plurality of light modulators comprises a plurality of liquid crystal cells.

14. The hybrid scan display according to claim 2, wherein the plurality of light modulators are arranged for operating in binary mode.
